(19) United States
(12) Patent Application Publication
(10) Pub. No.: US 2024/0370130 A1
(43) Pub. Date: Nov. 7, 2024

(54) IMMERSIVE REALITY METHOD AND SYSTEM FOR A HOUSEHOLD APPLIANCE

(71) Applicant: WHIRLPOOL CORPORATION, BENTON HARBOR, MI (US)

(72) Inventors: ROBERT RYAN BAER, CHICAGO, IL (US); MARCOS AURELIO DE SOUZA, JOINVILLE (BR); RYAN EBSTEIN, ST. JOSEPH, MI (US); CAMERON HAGEDON, GRAND RAPIDS, MI (US); KYLIE MARIE MCCOLLUM, ST. JOSEPH, MI (US); MATIAS SCHWAMBACH, SAO BENTO DO SUL (BR); CAROLINE PAIVA TORRES, JOINVILLE (BR); ERIC JAMES VASKO, ST. JOSEPH, MI (US)

(21) Appl. No.: 18/572,253

(22) PCT Filed: Jun. 24, 2022
(86) PCT No.: PCT/US2022/034816

§ 371 Date: Dec. 20, 2023

Related U.S. Application Data
(60) Provisional application No. 63/214,872, filed on Jun. 25, 2021.

(51) Int. Cl. G06F 3/04815; G06Q 30/0601; G06T 11/60

(52) U.S. Cl. CPC G06F 3/04815; G06Q 30/0631; G06T 11/60; G06T 2200/24

(57) ABSTRACT

A method and system for implementing an immersive reality view on an immersive reality device having a user interface and at least one receiving component. The method comprising acquiring a first set of characteristics of an environment, and acquiring a second set of characteristics of a household appliance, via the at least one receiving component, in order to determine one or more limitations of the household appliance based on one of the first or second set of characteristics. A simulation of the immersive reality view can include the household appliance within the environment including the one or more limitations.

### CROSS-REFERENCE TO RELATED APPLICATIONS

This application claims priority to and the benefit of U.S. Provisional Patent Application No. 63/214,872 filed Jun. 25, 2021, the entirety of which is incorporated herein by reference.

### BACKGROUND

An Augmented Reality (AR) device provides a user of the device with a real-world view enhanced with computer-generated objects such as text, images, videos, or data. The AR device refers to a device which includes an AR system or an AR application. For example, an AR device can be a user's smartphone. The real-world view is captured through a camera accessible to the AR device and projected onto an interface of the AR device. The AR system or application can recognize one or more objects or characteristics of objects within the real-world view and assign various computer-generated objects to the objects. As such, a combination of real-world objects and computer-generated objects can be displayed to the user through the interface of the AR device.

Traditionally, the AR device is used to place images or moving objects on the objects within the real-world. In some cases, the AR device can be used to identify objects within the real world and display general characteristics, titles, or information of the real-world object. For example, some AR systems can recognize what the real-world object is and display text identifying the real-world object.

### BRIEF SUMMARY

In one aspect, the present disclosure relates to a method of implementing an immersive reality view on a device having a user interface and at least one receiving component, the method comprising acquiring a first set of characteristics of an environment via the at least one receiving component, acquiring a second set of characteristics associated with a household appliance, via the at least one receiving component, comparing the second set of characteristics to the first set of characteristics to determine one or more limitations of the household appliance, and simulating the immersive reality view on the user interface of the device, the immersive reality view illustrating the household appliance within the environment and including the one or more limitations.

In another aspect, the present disclosure relates to a method of implementing an immersive reality view on an immersive reality device having a user interface, at least one receiving component, and an accessible memory, the method comprising acquiring a first set of characteristics of an environment via the at least one receiving component, wherein the first set of characteristics comprises at least one constraint of the environment, receiving a set of household appliances from the memory, with each household appliance including a second set of characteristics corresponding to at least one of a thermal emission, a water requirement, a drainage requirement, a light requirement, or a power requirement, or a space requirement of the household appliance, comparing the second set of characteristics to the first set of characteristics, determining which household appliance of the set of household appliances would be suitable for the environment based on the comparison, and simulating the immersive reality view on the user interface of the immersive reality device, the immersive reality view illustrating the determined household appliance within the environment.

### BRIEF DESCRIPTION OF THE DRAWINGS

In the drawings:

FIG. 1 illustrates a schematic representation of a communication between at least one household appliance within an environment and an immersive reality device in accordance with various aspects described herein.

FIG. 2 is a schematic representation of an immersive reality view on the immersive reality device of FIG. 1, further illustrating a set of computer-generated objects corresponding to an exemplary household appliance in accordance with various aspects described herein.

FIG. 3 is a schematic representation of an exemplary immersive reality view on the immersive reality device of FIG. 1, further illustrating a set of computer-generated instructions corresponding to the user of an exemplary household appliance in accordance with various aspects described herein.

FIG. 4 is a schematic representation of an exemplary immersive reality view on the immersive reality device of FIG. 1, further illustrating a set of computer-generated objects or instructions corresponding to a defective component of an exemplary household appliance in accordance with various aspects described herein.

FIG. 5 is a schematic representation of an exemplary immersive reality view on the immersive reality device of FIG. 1, further illustrating a set of computer-generated objects corresponding to a virtual household appliance in accordance with various aspects described herein.

FIG. 6 is a schematic representation of an exemplary immersive reality view on the immersive reality device of FIG. 1, further illustrating a set of computer-generated objects corresponding to an exemplary virtual household appliance that fits within the environment in accordance with various aspects described herein.

FIG. 7 is a schematic representation of an exemplary immersive reality view on the immersive reality device of FIG. 1, further illustrating a set of computer-generated objects corresponding to an exemplary virtual household appliance that does not fit within the environment in accordance with various aspects described herein.

FIG. 8 is a schematic representation of an exemplary immersive reality view on the immersive reality device of FIG. 1, further illustrating a set of computer-generated objects corresponding to an exemplary virtual household appliance that is not recommended for the environment in accordance with various aspects described herein.

FIG. 9 is a schematic representation of an exemplary immersive reality view on the immersive reality device of FIG. 1, further illustrating a set of computer-generated objects corresponding to an exemplary virtual household appliance that does not fit within the environment in accordance with various aspects described herein.

FIG. 10 is a schematic view of the immersive reality device of FIG. 1 demonstrating a method of purchasing a household appliance from a retailer, in accordance with various aspects described herein.

FIG. 11 illustrates a method of implementing an immersive reality view on the immersive reality device of FIG. 1.

FIG. 12 illustrates an exemplary method of implementing an immersive reality view on the immersive reality device of FIG. 1.

FIG. 13 illustrates a method of diagnosing a household appliance on the immersive reality device of FIG. 1.

### DETAILED DESCRIPTION

Aspects of the disclosure relate to a method and system for implementing an immersive reality view on an immersive reality device. As used herein, the term “immersive reality” can refer to a view of a real-world environment on a virtual interface and including at least one computer-generated object including computer generated animations. As such, an immersive reality view can refer to a view of a real-world environment through a virtual interface (e.g., a screen of a smartphone), with the immersive reality view including one or more computer-generated objects pertaining to at least a portion of the real-world environment. As a non-limiting example, immersive reality can include Augmented Reality (AR) or Virtual Reality (VR). The immersive reality device can include at least one user interface, at least one receiving component, and an accessible memory. For the purposes of illustration, aspects of the disclosure will be described in the exemplary environment of a smartphone defining an AR device. It will be understood that the disclosure is not so limited, and that aspects of the disclosure can be utilized in any immersive reality device can be at least one of an AR device or a VR device and further include, but is not limited to, a smartphone, a headset, a gaming platform, a telephone, a tablet, a computer, a kiosk, or a television in non-limiting examples.

The receiving component of the immersive reality device can sense and obtain data related to an object within an environment. As a non-limiting example, the receiving component on the immersive reality device can sense and obtain data related to a household appliance within an environment. The immersive reality view can then recognize and display the household appliance on the user interface of the immersive reality device. The receiving component can further sense and obtain data related to a first set of characteristics of the environment and a second set of characteristics of the household appliance. A set of computer-generated objects can be displayed on the immersive reality view corresponding to at least one of the first set of characteristics or the second set of characteristics. It will be appreciated that aspects of the disclosure can be utilized in any suitable environment including any suitable household appliance. As a non-limiting example, the environment can be, but is not limited to, a kitchen, a laundry room, a dining room, a living room, a retail store, or a restaurant in non-limiting example. Further, the household appliance can be, but is not limited to, a stove, a microwave, a refrigerator, a dishwasher, a laundry treating appliance (e.g., a washer, a dryer, a combination washer-dryer, etc.), a coffee machine, a blender, or a mixer in non-limiting examples.

While “a set of” various elements will be described, it will be understood that “a set” can include any number of the respective elements. It will be yet further understood that the “a set” can include only one element. Also, as used herein, while elements or components can be described as “sensing” or “measuring” a respective value, data, function, or the like, sensing or measuring can include determining a value indicative of or related to the respective value, data, function, or the like, rather than directly sensing or measuring the value, data, function, or the like, itself. The sensed or measured value, data, function, or the like, can further be provided to additional components. For instance, the value can be provided to a controller module or processor, and the controller module or processor can perform processing on the value to determine a representative value or an electrical characteristic representative of said value, data, function, or the like.

As used herein, a “system” or a “controller module” can include at least one processor and memory. Non-limiting examples of the memory can include Random Access Memory (RAM), Read-Only Memory (ROM), flash memory, or one or more different types of portable electronic memory, such as discs, Digital Versatile Discs (DVDs), Compact Disc-Read Only Memory (CD-ROMs), etc., or any suitable combination of these types of memory. The processor can be configured to run any suitable programs or executable instructions designed to carry out various methods, functionality, processing tasks, calculations, or the like, to enable or achieve the technical operations or operations described herein. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

Reference will now be made in detail to aspects of the disclosure, one or more non-limiting examples of which are illustrated in the FIGS. Each example is provided by way of explanation of the disclosure, not limitation of the disclosure. In fact, it will be apparent to those skilled in the art that various modifications and variations can be made in the present disclosure without departing from the scope or spirit of the disclosure. Thus, it is intended that the present disclosure covers such modifications and variations as come within the scope of the appended claims and their equivalents.

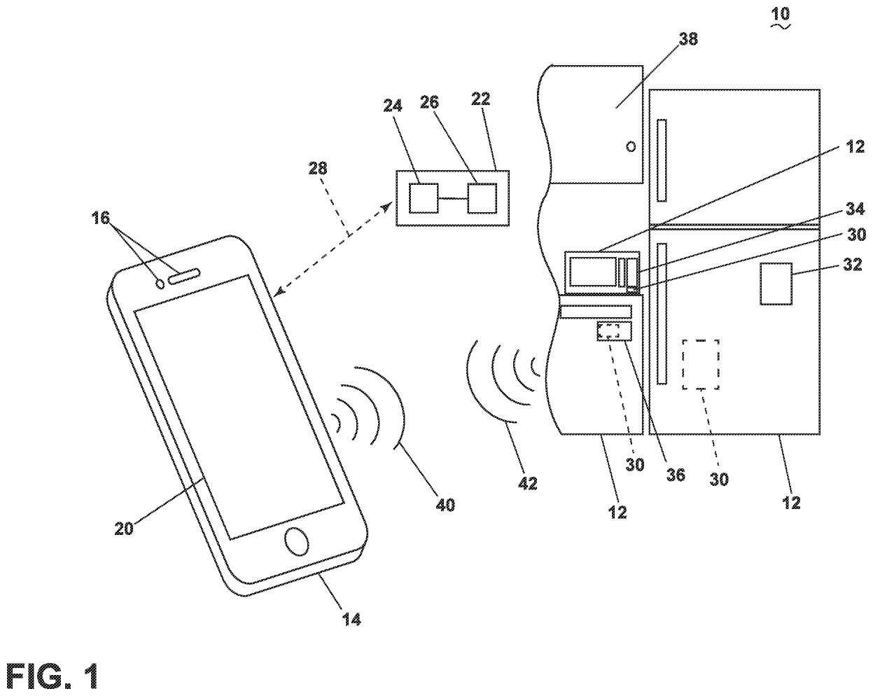

FIG. 1 illustrates a schematic representation of an immersive reality device 14 configured and adapted for use within an environment 10 including one or more household appliances 12. As illustrated, the environment 10 is a kitchen, the immersive reality device 14 is a smartphone, while the one or more household appliances 12 include a refrigerator, a microwave, and a dishwasher. It will be appreciated, however, that the environment 10 can include any suitable environment such as, but not limited to, a kitchen, a laundry room, a dining room, a living room, a retail store, or a restaurant. It will be further appreciated that the immersive reality device 14 can be any suitable device such as, but not limited to, a smartphone, a headset, a gaming platform, a telephone, a tablet, a camera, a computer, a kiosk, or a television. It will be yet further appreciated that the set of household appliances 12 can include, but are not limited to, a stove, a microwave, a refrigerator, a dishwasher, a laundry treating appliance (e.g., a washer, a dryer, a combination washer-dryer, etc.), a coffee machine, a blender, or a mixer. It will be appreciated that the immersive reality device 14, the environment 10, and the set of household appliances 12 are all shown in schematic representations. As such, each element described herein can include one or more elements or functions that are not listed herein.

The immersive reality device 14 can include one or more receiving components 16 or sensors, and a user interface 20. As used herein, the term “receiving component” or iterations thereof can refer to one or more components of the immersive reality device configured to detect, measure, obtain, collect or otherwise receive a set of characteristic data corresponding to the environment 10, or the household appliance 12. As a non-limiting example, the set of receiving components 16 can include, but are not limited to, a camera, a microphone, a Bluetooth module, a WIFI module, a Near Field Communication (NFC) module, a memory accessible to the immersive reality device, or any combination thereof. The set of characteristic data can include any suitable data such as, but not limited to, a set of audio data, a set of visual data, a set of positioning data (e.g., Global Positioning System (GPS)), a set of characteristics or data corresponding to the environment 10, a set of characteristics or data of the household appliance 12, or any combination thereof. The set of audio data and the set of visual data can, for example, include an audio recording or visual recording, respectively. As a non-limiting example, the one or more receiving components 16 can include a microphone and a camera. The one or more receiving components 16 can be configured to acquire or detect audio within or outside of the human hearing range (e.g., between 20 to 20,000 Hz). Further, the one or more receiving components 16 can be configured to record video or capture images within or outside of the visible light spectrum. Although illustrated as only being provided on the side of the immersive reality device 14 including the user interface 20, it will be appreciated that the set of receiving components 16 can be provided along any portion of the immersive reality device 14 or otherwise be accessible to the immersive reality device 14. As a non-limiting example, the set of receiving components 16 can include a camera on the side opposite the user interface 20. As yet another non-limiting example, the set of receiving components 16 can include a webcam that is not physically coupled to the immersive reality device 14 yet is accessible to the immersive reality device 14 through a wired connection or a wireless connection (e.g., WIFI, Bluetooth, Near Field Communications (NFC), etc.). The user interface 20 can be any suitable user interface 20 coupled to or otherwise accessible to the immersive reality device 14. As a non-limiting example, the user interface 20 can be a touch screen for a smartphone.

The immersive reality device 14 can further be defined as a device that has immersive reality capabilities. As used herein, the term “immersive reality capabilities”, or iterations thereof, can refer to the capability, capacity, potential, or ability of a device (e.g., the immersive reality device 14) to generate an immersive reality view. As a non-limiting example, the immersive reality device 14 can include immersive reality capabilities by including pre-existing immersive reality software. In other words, the immersive reality device 14 can be designed to include immersive reality capabilities such that the immersive reality device 14 can generated an immersive reality view. As another non-limiting example, the immersive reality device 14 can include the immersive reality capabilities through an application on the immersive reality device 14. In other words, an application can be downloaded, saved, or otherwise run through the immersive reality device 14, with the application having the ability to run or otherwise generated the immersive reality view, which can then be displayed through the immersive reality device 14.

A computing device 22 can be accessible to the immersive reality device 14. As shown, the computing device 22 can be a controller module or a microcontroller. The computing device 22 can be stand-alone or can be embedded within the immersive reality device 14. In other words, the computing device 22 can be exterior to the immersive reality device 14, or the computing device 22 can be included within and define a portion of the immersive reality device 14. In either case, the computing device 22 can be accessible to the immersive reality device. As used herein, the term “accessible to” or iterations thereof, can refer to the capability of a device (e.g., the immersive reality device 14) to utilize the functions of a specific element. As a non-liming example, the immersive reality device 14 has access to the computing device 22 such that the immersive reality device 14 can utilize the functions, or components of the computing device 22. The computing device 22 can include one or more processors 24 and a memory 26. The one or more processors 24 can be any suitable processing device, including, but not limited to, a processor core, a microprocessor, an Application Specific Integrated Circuit (ASIC), a Field Programmable Gate Array (FPGA), a controller, a microcontroller, a controller module, or the like. In another non-limiting example, the one or more processors 24 can include of processors or processor execution cores that are operatively connected. The memory 26 can include one or more non-transitory computer-readable storage mediums, such as RAM, ROM, EEPROM, EPROM, flash memory devices, magnetic disks, the like, or a combination thereof. The processor 24 and the memory 26, together, can supply the immersive reality capabilities to the immersive reality device 14. The memory 26 can also store one or more sets of data corresponding to the environment 10 or the set of household appliances 12. It is contemplated that at least a portion of the computing device 22 can be defined by or otherwise have access a cloud-based storage or the internet. As a non-limiting example, at least a portion of the memory 26 can be defined by a cloud-based storage including the data concerning the environment 10 and the set of household appliances 12. As such the computing device 22 can access the cloud-based storage to obtain information related to the environment 10 or the set of household appliances 12.

The immersive reality device 14 and the computing device 22 can be connected via a connection 28. The connection 28 can be a wired or wireless connection between the immersive reality device 14 and the computing device 22. The connection 28 can be a two-way connection such that the immersive reality device 14 can send commands to the computing device 22 and vice-versa. It is contemplated that the immersive reality device 14 can further request information from the memory 26 or a memory accessible to the computing device 22, and the computing device 22 can return the requested information. As a non-limiting example, the immersive reality device 14 can request information concerning the set of household appliances 12 or the environment 10 and the computing device 22 can return the requested information to be ultimately displayed to a user on the user interface 20.

As illustrated, the environment 10 can further include one or more non-appliance elements 38 that are separate from the one or more household appliances 12. As a non-limiting example, the non-appliance elements 38 can include, but are not limited to, a cabinet, a countertop, a drawer, a pantry, a wall, a vent, a light or set of lights, an electrical hook-up, a gas line hook-up, a water supply or water drain, or any combination thereof.

The environment 10 can be defined by a first set of characteristics. As a non-liming example, the first set of characteristics can include at least one of, but are not limited to, a size, a makeup (e.g., what is included within the environment 10), a temperate, a humidity, a constraint, a geographical location of the environment 10, a map or layout of the environment 10, a disposition of objects (e.g., the household appliance 12 or non-appliance elements 38), a type of environment 10, materials used in the environment 10 or any available elements of the environment 10 (e.g., any air, data (Wi-Fi or Ethernet), power, gas or water supply systems available in the environment 10). As a non-limiting example, the constraint of the environment 10 can include an available space of the environment (e.g., space not including the non-appliance element 38 or the set of household appliances 12). It will be appreciated that the first set of characteristics can include, for example, the number of non-appliance elements 38, the number of household appliances 12, the spacing between the non-appliance elements 38 and the household appliances 12, the location of the non-appliance elements 38 and the household appliances 12, an operational communication between one or more of the household appliances 12 and other household appliances 12 or the non-appliance elements 38, or any combination thereof. As a non-limiting example, the operational communication can include information such as the effect the operation of a household appliance 12 will have on a household appliance 12 or non-appliance element 38 that is adjacent to, contacting, or spaced from the household appliance 12. For example, if the operation of the household appliance 12 releases a heat or a vapor, the first set of characteristics can include the effect that the heat or vapor would have on adjacent household appliances 12 or adjacent non-appliance elements 38.

The set of household appliances 12 can be defined by a set of second characteristics. as a non-limiting example, the second set of characteristics can include a set of operational characteristics or requirements of the household appliance include, but not limited to, but are not limited to, a status (e.g., “ON” or “OFF”), a thermal emission, a water requirement, a gas requirement, a power requirement, a volume, a Wi-Fi or data connection requirement, a clearance requirement, a safety distance requirement (e.g., the distance required between the household appliance 12 and another object or person needed to operate the household appliance 12 safely), a vent requirement, a drainage requirement, a light requirement (e.g., the needed light from the environment 10 to properly operate the household appliance 12), a footprint, a space requirement for one or more components of the household appliance 12 (e.g., a drawer, a rack, etc.), a fault, a maintenance requirement, an element (e.g., an ice/water dispenser, a user interface, a door handle, etc.), a type, a make, a model number, or a registration number or registration requirement (e.g., the household appliance 12 needs to be registered), a network connection requirement (e.g., a requirement for the household appliance 12 to connect to an external network such as, but not limited to, WIFI or data connections), or any combination thereof.

The first set of characteristics, and the second set of characteristics can together, or separately, define one or more functional limitations of the household appliance 12 within the environment 10. The functional limitations can be further defined as one or more limitations of a household appliance 12 that are present due the household appliances 12 positioning within the environment 10. In other words, the functional limitations can quantify the relationship between the household appliance 12 and other household appliances, or non-appliance elements 38 within the environment 10 based on the operation or the presence of the household appliance 12, or for its specific intended or installed position. Non-limiting examples of the functional limitations include, but are not limited to, an effect on the environment 10 from a heat or humidity emitted from the household appliance 12, an effect on the environment 10 from an operation of the household appliance 12 (e.g., opening a drawer, opening a door, the movement or vibration of the household appliance 12 during operation, etc.), the interference of the household appliance 12 with the environment 10 (e.g., a portion of the household appliance 12 contacting a portion of the environment due to the vibration, movement, sound, etc. of the household appliance 12), a determination if a requirement of the household appliance 12 is met by environment 10 such as, but not limited to, venting requirements, drain requirements, water requirement, power/energy requirements, performance requirements (e.g., optimal, or minimum requirements needed for the household appliance 12 to operate as intended), gas requirements, or any combination thereof. As a non-limiting example, the effect on the environment 10 from the heat, the vibration, the humidity, the movement, or any other functional limitation can include the effect the household appliance 12 has on the environment 10 based on the disposition of the specific elements within the environment 10. As a non-limiting example, an adjacent non-appliance element 38 to the household appliance 12 can include a material that can be damaged (e.g., dented, melted, cracked, etc.) by the household appliance 12, specifically by the functional limitations, installation, or operation of the household appliance 12.

At least one of the household appliances can further include a controller defining a human-machine interface (HMI) 30. As used herein, a “Human-Machine Interface” can be any suitable interface on the household appliance 12 that is used to communicate one or more characteristics of the household appliance 12 to the user. As a non-limiting example, the HMI 30 can include any suitable communication device such as, but not limited to, an audio indicator (e.g., a speaker) or a visual indicator (e.g., a light, a screen, etc.), a sensor, a wireless transmitter, a wireless transponder, a wired connection, or any combination thereof. The HMI 30 can be designated to the household appliance 12 and communicate at least a portion of the second set of characteristics. In other words, the HMI 30 can contain the information relating to the second set of characteristics and be able to communicate at least a portion of the second set of characteristics to the immersive reality device 14.

At least one of the household appliances 12 can include an additional element that defines the second set of characteristics. For example, one of the household appliances can be refrigerator and include an ice/water dispenser 32, another household appliance 12 can be a microwave including a keypad 34, while a third household appliance 12 can be a dishwasher including a user interface 36. The second set of characteristics can include the operational state or the use/purpose of these additional elements. Although illustrated as the ice/water dispenser 32, the keypad 34, and the user interface 36 it will be appreciated that any household appliance 12 can include any suitable additional element such as, but not limited to, a button, a screen, a switch, a knob, a handle, an interface, a clock, a function, or any combination thereof.

The immersive reality device 14 can recognize each household appliance 12 and the non-appliance element 38 such that the immersive reality device 14 can differentiate between the element 38 from the household appliance 12. The immersive reality device 14 can further include a first communication 40 with the environment 10. The first communication 40 can be a visual representation of the video recording or audio recording of the set of receiving components 16 as described herein. The first communication 40 can be configured to acquire or detect at least one of the first set of characteristics of the environment 10 or the second set of characteristics of the set of household appliances 12. As such, the immersive reality device 14 can gather the first set of characteristics and the second set of characteristics through use of the set of receiving components 16.

It is further contemplated that the set of household appliances 12 can include a second communication 42 with the immersive reality device 14. This second communication 42 can either be the return communication as discussed above, or a communication sent by the household appliance 12 and to the immersive reality device 14. The second communication 42 can be illustrative of an audio, a visual indication, a wireless transmission, or a wired transmission. It is contemplated that the HMI 30 can include at least one communication component (e.g., a speaker, a light such as an LED, a wireless transmitter, etc.) that can allow for the HMI 30 to communicate with the immersive reality device 14. As a non-limiting example, the second communication 42 can be a communication sent from the HMI 30. The HMI 30 can then use its communication device to generate a light pattern, audio pattern, or a wireless communication that is received by the set of receiving components 16. As such, the second set of characteristics can be communicated to the immersive reality device 14 through the set of receiving components 16.

It will be appreciated that the second communication can be a physical communication or otherwise a representation of a feedback to the immersive reality device 14. As a non-limiting example, at least one of the household appliances 12 does not include the second communication 42. In other words, in a non-limiting example, at least one of the household appliances 12 does not include the HMI 30 or any other capability to produce a physical second communication 42 with the immersive reality device 14. As such, the immersive reality device 14 can recognize and differentiate household appliances 12 based on the characteristics of the household appliances 12. This can be done without the household appliance 12 producing the second communication 42 to communicate the characteristics of the respective household appliance 12 to the immersive reality device 14. As a non-limiting example, the immersive reality device 14 can recognize a specific household appliance 12 by analyzing the video or audio recordings from the receiving components 16. For example, the immersive reality device 14 can recognize a specific household appliance 12 based on its physical characteristics such as, but not limited to, its shape, size, color, location, or any combination thereof. As another non-limiting example, the immersive reality device 14 can recognize the household appliance 12 based on any one or more visual or audio indicators form the household appliance itself. For example, the household appliance can include non-visual indicators (e.g., an audio) or visual indicators (e.g., an LED or the HMI 30) that the immersive reality device 14 can capture with the set of receiving components 16, and ultimately use to identify each household appliance 12. It will be appreciated that the immersive reality device can use any other suitable method to recognize the household appliances 12 and differentiate between household appliances 12 such as, but not limited to, scanning a code (e.g., a Quick Response (QR) code, a barcode, etc.), physical input by the user (e.g., the user can physically input which device is which on the immersive reality view 44), cross reference to a database accessible to the immersive reality device 14 containing one or more pre-registered devices that are known to be within the environment 10, or any combination thereof.

As discussed herein, the set of receiving components 16 can be used to obtain, measure, or otherwise receive characteristic data of the environment 10 and the household appliance 12. As a non-limiting example, the characteristic data obtained by the set of receiving components 16 can include the first set of characteristics and the second set of characteristics. The characteristic data can be obtained through any suitable method. As a non-limiting example, the characteristic data can be measured through use of receiving component 16 including a camera such that the immersive reality device 14 can use visual recordings to gather and measure the characteristic data of the environment 10 and the household appliance 12. It will be further appreciated, however, that the characteristic data corresponding to at least one of the environment 10 or the household appliance 12 can be received by the immersive reality device 14 through a data acquisition. As used herein, the term “data acquisition” or iterations thereof can refer to any suitable transmittal, or trading of data representative of the environment 10, and/or the household appliance 12 to the immersive reality device 14. As a non-limiting example, data acquisition can occur by transmitting data from at least one of the environment 10 (e.g., a transmitter, a WIFI router, a Bluetooth module, an NFC module, a speaker, etc.) or the household appliance 12 (e.g., a transmitter, a WIFI module, a Bluetooth module, a speaker, the HMI 30, an NFC module, etc.) to at least one of the receiving components 16 of the immersive reality device 14. As a non-limiting example, the immersive reality device 14 can include a receiving component 16 including a Bluetooth module that can communicate with or link to one or more Bluetooth-enabled devices within the environment 10 (e.g., devices containing a Bluetooth module) or a Bluetooth-enabled household appliance 12. As such, the characteristic data of the environment 10 or the household appliance 12 can be transmitted to the immersive reality device 14 through Bluetooth. It will be further appreciated that the first set of characteristics and the second set of characteristics can be obtained through any other suitable method such as, but not limited to, pattern recognition (e.g., an audio or visual pattern), Artificial Intelligence (AI) provided on or accessible to the immersive reality device 14, an at least partially trained Artificial Neural Network (ANN) provided on or accessible to the immersive reality device 14, an Expert Diagnostic System (EDS) provided on or accessible to the immersive reality device 14, or any combination thereof.

It will be appreciated that each household appliance 12 can include a separate second set of characteristics. In other words, a refrigerator will have differing characteristics than other appliances such as a microwave. Thus, the environment 10 can contain multiple second sets of characteristics. It will be appreciated, however, that the set of first characteristics is a set of characteristics of the environment 10 as a whole (e.g., including each household appliance 12 and non-appliance elements 38). As such, each environment 10 includes only one set of first characteristics. It will be further appreciated that each element within the environment 10 can also include separate first set of characteristics such that the first set of characteristics of the environment 10 includes multiple first set of characteristics of each individual element within the environment 10. It is further contemplated that the first set of characteristics can include sets of characteristics of other household appliances 12 within the environment 10. As a non-limiting example, the environment 10 can include a household appliance 12, in which the second set of characteristics are generated for, another household appliance, and a non-appliance element 38. The household appliance 12, in which the second set of characteristics is not generated for, and can have a set of characteristics and the non-appliance element 38 can have another set of characteristics. These two sets of characteristics can be included within the first set of characteristics of the environment. It is contemplated that the immersive reality device 14 can determine which household appliance 12 to generate or retrieve the second set of characteristics for through selection by a user (e.g., the user points towards, provides audible instruction, touches, motions towards, or touches on the immersive reality device 14 which household appliance 12 they would like to select), automatic determination (e.g., the household appliance 12 is the only household appliance 12 within the environment 10), or by pointing the immersive reality device 14 directly toward the household appliance 12. As a non-limiting example, the user can point a camera of the immersive reality device 14 toward the household appliance 12. The pointing of the camera can result in the selection of the household appliance 12 and the generation or the retrieval of the second set of characteristics.

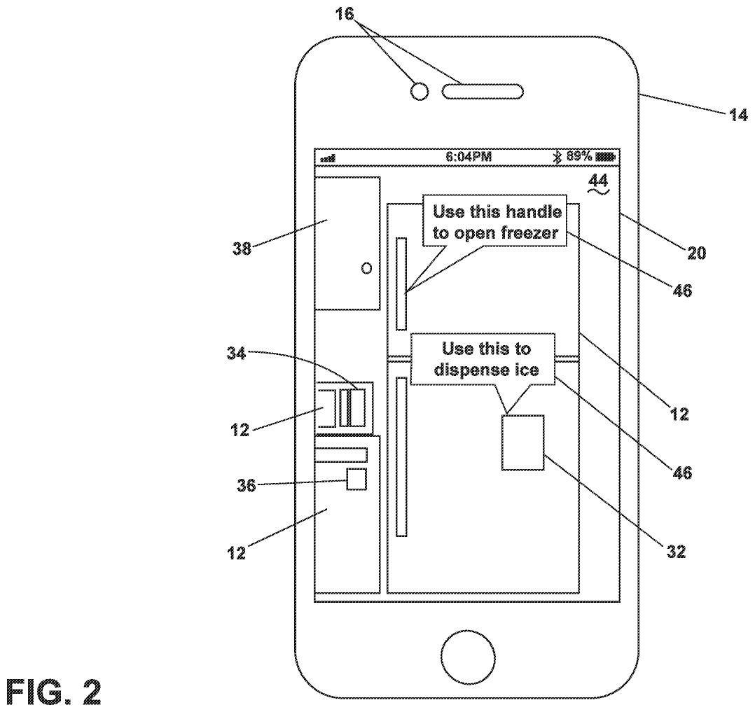

FIG. 2 is a schematic representation of an immersive reality view 44 on the immersive reality 14 device of FIG. 1. The immersive reality view 44 can be displayed on the user interface 20 of the immersive reality device 14. The user interface 20, as illustrated, includes a touch screen of the immersive reality device 14. It will be appreciated that the user interface 20, however, can include any suitable element configured to communicate or portray the immersive reality view 44 to the user. As a non-limiting example, the user interface 20 can include elements, but is not limited to, such as a non-touch screen (e.g., a television or monitor), a touch screen, a microphone, a projector, or any combination thereof. It will be appreciated that the immersive reality view 44, as illustrated, can include at least one real-world element (e.g., the non-appliance elements 38, and the set of household appliances 12) alongside a set of computer-generated elements 46. As used herein, the phrase “computer-generated elements” can refer to any element within the immersive reality view 44 that is not present in the real-world environment 10. The computer-generated elements 46 can be created through the immersive reality capabilities of the immersive reality device 14.

In operation, a user can activate the immersive reality capabilities of the immersive reality device 14 and point the immersive reality device 14 toward the environment 10. As a non-limiting example, the user can open an immersive reality application on their immersive reality device 14 and position at least one of the receiving components 16 within or accessible to the environment 10 such that the receiving component 16 can generate, sense, capture, infer, collect, or receive the first communication 40 or the second communication 42 (FIG. 1). In other words, the user can position their immersive reality device 14 such that the set of receiving components 16 can capture at least one of an audio recording or a visual recording of the environment 10 and the elements within the environment 10 (e.g., the set of household appliances 12 and the non-appliance elements 38). As such, the immersive reality device 14 can recognize aspects of the non-appliance elements 38, the household appliances 12, and the environment 10 through use of the set of receiving components 16. As a non-limiting example, the immersive reality device 14 can receive, obtain, collect, or otherwise derive at least one of the first set of characteristics of the environment 10 or the second set of characteristics of the set of household appliances 12 via the set of receiving components 16. At least a portion of the environment 10 can be displayed within the immersive reality view 44.

The immersive reality capabilities of the immersive reality device 14 can display the computer-generated elements 46 based on at least one of the first set of characteristics or the second set of characteristics. The computer-generated elements 46 can include or highlight functional aspects of the household appliance 12. As a non-limiting example, one of the computer-generated elements 46 can point toward a handle of the freezer door of the household appliance 12 and provide a description of what the handle is used for or otherwise highlight how a user could obtain access to the freezer. As a non-limiting example, another computer-generated element 46 can highlight or point towards the ice/water dispenser 32 and inform the user of the immersive reality device 14 that the ice/water dispenser 32 can be used to dispense ice. It will be appreciated that the computer-generated elements 46 can be created for any static or dynamic configuration that the household appliance 12 will consume within the environment 10. As a non-limiting example, the computer-generated elements 46 can be created for the functional limitations (e.g., the opening of a door, the operation of the appliance, etc.) of the household appliance 12. It will be appreciated that the computer-generated elements 46 could be static, dynamic, or a combination thereof. Further, it will be appreciated that the computer-generated elements 46 can include a text, an image, a video, an animation, or combination thereof. As a non-limiting example, a computer-generated element 46 could indicate which way a door of the household appliance 12 would open. The computer-generated element 46, in this case, could be a dynamic arrow which moves in the direction that the door of the household appliance 12 will open.

It is contemplated that the immersive reality device 14 can determine which set of second characteristics and which computer-generated elements 46 to display based on user input. As a non-limiting example, the user can point the set of receiving components 16 directly at the refrigerator, and the immersive reality device 14 will know that the user only wants computer-generated elements 46 based on the second set of characteristics of the refrigerator to be displayed. The user interface 20 and the immersive reality view 44 can simulate exactly where the user is pointing the set of receiving components 16 within the environment 10 so the user can easily and accurately acquire the information they desire. Alternatively, the user can select, trough the user interface 20, which appliance they wish to have the computer-generated elements 46 pop up on. As illustrated, the immersive reality view 44 includes the microwave, the dishwasher, and the refrigerator. It is contemplated that the user could use the user interface 20 to select which of the three household appliances within the environment 10 they wish to have the computer-generated elements 46 pop up for. It will be appreciated that the selection of the household appliances 12 is not constrained to being between household appliances 12. As a non-limiting example, the user of the immersive reality device 14 could select various portions of the household appliance to have computer-generated elements 46 pop up for said element. For example, the user could select the ice/water dispenser 32 such that a computer-generated element 46 explaining the purpose/use of the ice/water dispenser 32 only is displayed. As a non-limiting example, the user interface 20 could be a touch screen and the user could physical touch the household appliance 12 on the user interface 20 in order to select the household appliance 12. Alternatively, the household appliance 12 can be selected by the user through other methods such as, but not limited to, pointing, looking at the household appliance 12, positioning the immersive reality device 14 towards the household appliance 12, voice commands, selection within a menu on the immersive reality device, physical touch, or any combination thereof.

It is yet further contemplated that once the household appliance 12 is selected or once the household appliances 12 are recognized and differentiated if the environment 10 includes a set of household appliances 12, the immersive reality device can access a database from memory (e.g., memory 26 or a cloud-type storage) to determine additional characteristics that would otherwise be listed within a user manual of the household appliances 12. These additional characteristics can be included within the second set of characteristics. The additional characteristics can include, but are not limited to, a clearance requirement, a vent requirement, a gas requirement, a power requirement, a drainage requirement, a light requirement, or any combating thereof. These additional characteristics are all characteristics that a user would not know the specifics of unless they already had pre-existing knowledge or the household appliance 12. As a non-limiting example, the immersive reality device 14 can obtain measurements of the environment 10 including the spacing between the household appliances 12 and corresponding portions of the environment 10. The immersive reality device 14 can cross-reference these measurements to ensure that the constraints of the household appliances 12 obtained from the database are fully satisfied. As a non-limiting example, the immersive reality device 14 can obtain the clearance constraint between the household appliance 12 and a portion of the environment 10 (e.g., a cabinet or another household appliance 12) from the database. The immersive reality device 14 can cross-reference the clearance constraint with the physical clearance or the estimated clearance of the household appliance 12 and the environment 10. As a non-limiting example, the refrigerator, as illustrated, can require 3 inches of clearance between the household appliance 12 and other portions of the environment 10 due to heat dissipation requirements of the household appliance 12. The immersive reality device 14 can access this clearance constraint from the database and determine whether or not the clearance constraint is met/can be met with the current positioning of the household appliance 12. If it is determined that there is not enough clearance, the computer-generated elements 46 can indicate as much and recommend to the user that they move the household appliance 12 so the constraints are met.

It is contemplated that the immersive reality device 14 can further be used to provide enhanced accessibility to the user of the immersive reality device 14. As used herein, the term “enhanced accessibility” or iterations thereof, can refer to the ability for the immersive reality device 14 to provide a medium (e.g., through the user interface 20) to which the user can easily and effectively understand what is being portrayed through the immersive reality view 44. As a non-limiting example, the immersive reality device 14 can be used to provided enhances accessibility so a user who is visually impaired, audibly impaired, or physically impaired to easily use the immersive reality device 14 and the household appliances 12. As a non-limiting example, the computer-generated elements 46 can be audible computer-generated elements 46 such that if the user were visually impaired, the computer-generated elements 46 could be efficiently and effectively portrayed to the user. Further, additional computer-generated elements 46 could be generated that would not otherwise be present if the user were not impaired in some way. As a non-limiting example, if the user is audibly impaired and the household appliance 12 is making a noise (e.g., a noise indicative of a fault or faulty component), the immersive reality device 14 could display a message through a visual computer-generated element 46 on the immersive reality view 44 indicating to the user that the household appliance 12 is making a noise, how loud the noise is, and why the noise is occurring. It is further contemplated that the immersive reality device 14 could supply additional enhanced accessibility by automatically translating portions of the household appliances 12 that can be in a non-native language that the user into the user's native language in order to ensure that the user can effectively use the household appliances 12. As a non-limiting example, the household appliances 12 can include instructions written onto the household appliance 12 indicating various functions of the household appliances 12. These instructions or prompts can be in a language that is non-native to the user, or in a language the user is unable to understand. The user could user their immersive reality device 14 to automatically translate the portions of the of household appliance 12 in the non-native language. Computer-generated elements 46 could then be generated and displayed to the user in their native or preferred language. The user could then use these computer-generated elements 46 to effectively, fully, and accurately understand the various functionalities of the household appliances 12.

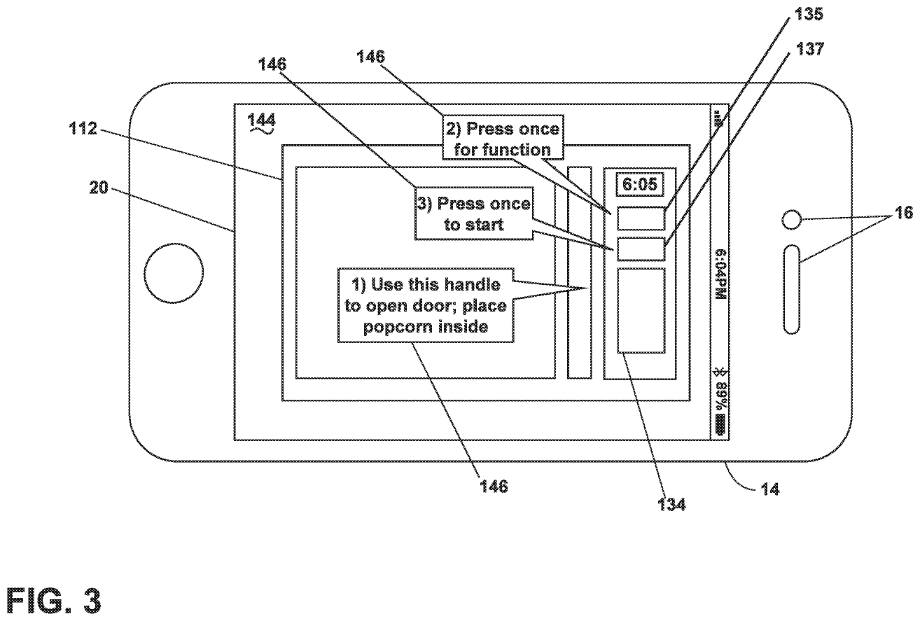

FIG. 3 is a schematic representation of an exemplary immersive reality view 144 on the immersive reality device 14 of FIG. 1. The exemplary immersive reality view 144 is similar to the immersive reality view 44; therefore, like parts will be identified with like numerals in the 100 series, with it being understood that the description of the like parts of the immersive reality view 44 applies to the exemplary immersive reality view 144 unless otherwise noted.

The immersive reality view 144 is similar to the immersive reality view 44 in that it includes a set of computer-generated elements 146 corresponding to a household appliance 112 within an environment (e.g., the environment 10 of FIGS. 1-2). As illustrated, the household appliance 112 is a microwave. It will be appreciated, however, that the household appliance 112 as described herein can be any suitable household appliance 112. The computer-generated elements 146 can be any suitable computer-generated elements 146 such as, but not limited to, messages containing text, videos, animations, interactive elements, links, or any combination thereof.

The household appliance 112 can include a keypad 134, a function button 135, and a start/stop button 137. The function button 135 can be a button which calls upon any suitable pre-loaded function of the household appliance 112. The function button 135 can call upon a pre-loaded or pre-saved to an internal memory commands or functions of the household appliance 112 such as, but not limited to, a recipe. As a non-limiting example, the function button 135 as illustrated can be used to call upon a recipe for making popcorn.

In operation, the user of the immersive reality device 14 could request, via selection or input, that they wanted to learn how to use or set-up the appliance. The immersive reality device 14 could show an overview demonstration of features and functionality of the appliance or show a demonstration of how to set up, move, or install the appliance. Moreover, if a user were interested in a specific feature of the appliance, such as how to make popcorn, the immersive reality device 14 could demonstrate the use the household appliance 112 to make popcorn. The set of computer-generated elements 146 could then be displayed in sequential order to walk the user through how to make popcorn with the household appliance 112. As a non-limiting example, a first computer-generated element 146 could highlight the handle of the household appliance 112 that can be used to open the household appliance 112 and expose the interior where the popcorn can be placed. A second computer-generated element 146 could highlight the functional button 137 or the keys on the keypad 134 that need to be pressed in order to bring up the recipe for the popcorn (e.g., set a cooking time). A third computer-generated element 146 could highlight the start/stop button 137 that needs to be touched in order to start the household appliance 112. The first, second, and third computer-generated elements 146 are shown to all be on the screen at once with labels of “1”, “2”, and “3” to denote the sequence of which they should occur. It will be appreciated, however, that each computer-generated element 146 can pop up once it has determined that the previous step has been performed. As a non-limiting example, if the immersive reality device 14 determines that the function button 135 has been pressed, the next computer-generated element 146 highlighting the start/stop button 137 could then be highlighted.

Although described in terms of providing instructions on how to make popcorn on a microwave, it will be appreciated that the immersive reality device 14 and the immersive reality view 144 can be used to display instructions on how to make any suitable recipe for any suitable household appliance 12. Alternatively, the instructions can be for any function of the household appliance 12 and is not just limited to recipes. As a non-limiting example, the computer-generated elements 146 could be generated for a refrigerator (FIG. 1-2) that would walk the user through how to use the ice/water dispenser 32. In another non-limiting example, the computer-generated elements 146 could be generated for a dishwasher (FIG. 1-2) that would walk the user through how to load consumables into the dishwasher (e.g., soap, detergent, etc.), and select/start the cleaning function. The instructions provided by the computer-generated elements 146 can be, but are not limited to, instructions for a recipe, instructions on how to use the household appliance 112, instructions on how to move the household appliance 112, instructions on how to install the household appliance 112, instructions on how to set up the household appliance 112, or instructions on how to register the household appliance 112. As a non-limiting example, instructions for how to use the household appliance 112 can include, but are not limited to, how to turn on the household appliance 112, how to register the household appliance 112, how to load a consumable into the household appliance 112 (e.g., laundry detergent, dish soap, carbonated gas cannister, a filter, water, etc.), how to use one or more components (e.g., the ice/water dispenser 32) of the household appliance 112, or any combination thereof.

Further yet, it is contemplated that the immersive reality device 14 can be used to monitor and display the status of the household appliance 112. As a non-limiting example, the immersive reality view 144 can display computer-generated elements 146 corresponding to the status or progress of the household appliance 112. The status or progress can be related to the status of the household appliance 112 during the execution of specific instruction. As a non-limiting example, the user can use the immersive reality device 14 to cook a meal. An instruction could be displayed through the computer-generated elements 146 that the meal needs to be cooked at a defined temperature for defined time period. The computer-generated elements 146 could be displayed to walk the user through how to set the temperature, time and how to begin/start cooking. Once the user has started cooking, computer-generated elements 146 could be displayed corresponding to the status of the household appliance 112 or the recipe to cook the meal. As a non-limiting example, a computer-generated element 146 could display a timer that indicates to the user the remaining time needed to cook the meal. As a non-limiting example, the immersive reality device 14 could also display computer-generated elements 146 based on the user's preference for the meal. In other words, the immersive reality device 14 could display to the user the timings needed to produce a meal with varying levels of cook. As a non-limiting example, the immersive reality device 14 could display to the user that they should cook the meal for 10 minutes to reach a first cook level, 20 minutes to reach a second cook level, and 30 minutes to reach a third cook level, with the first cook level being the least cooked and the third cook level being the most cooked. It will be appreciated that the immersive reality device 14 can be used to display the status of any suitable function or instruction corresponding to the household appliance 112 such as, but not limited to, a cooking time, a washing time, a freezing time, a drying time, a steaming time, a brewing time, or any combination thereof.

It will be appreciated that the instruction presented can be any suitable instruction. For example, the instructions can be how to perform a function of the household appliances 112, how to register the household appliance 112, how to install the household appliance 112, how to order new parts for a household appliance 112, how to shop for a new household appliance 112, how to move the household appliance 112, how to set up the household appliance 112, how to register the household appliance 112, how to replace consumables of the household appliance 112, how to clean portions of the household appliances 112 (e.g., the interior, lint traps, hair baskets, drains, plates, shelves, etc.), or any combination thereof.

As a non-limiting example, when a user first installs a household appliance 112 within their environment 10, the household appliance 112 can require registration with the user to unlock all of its functions. As used herein, the term “registration”, “register”, or iterations thereof can refer to the assignation of the specific household appliance to the user or the users account. As a non-limiting example, the immersive reality device 14 can use an immersive reality application that can require the household appliance 112 be registered with the user of the application before the immersive reality device 14 can display all of the computer-generated elements 146, as discussed herein, or to perform other functions of the household appliance 112 (e.g., connect the household appliance 112 to a local network, load user preferences onto the household appliance, etc.). It will be appreciated that the immersive reality device 14 can provide instructions to the user on how to register the household appliance 112 before the household appliance 112 is registered. As a non-limiting example, the household appliance 112 can require that button be pushed, a door be opened, a code (e.g., QR code, barcode, etc.) be scanned, or any other suitable function be performed in order to register the household appliance 112. As such, the immersive reality device 14 can recognize the household appliance 112 appliance is not registered through the set of receiving components 16 or through user input (e.g., the user can tell the immersive reality device that they want to register the household appliance 112). Computer generated elements 146 can then be displayed on the immersive reality view that walk the user through, step-by-step, on how to register their household appliance 112. As a non-limiting example, the user could register their household appliance 112 by positioning the household appliance 112 within the immersive reality view 144, or otherwise selecting the household appliance 112. The immersive reality device 14 could recognize the household appliance 112 based on at least one of a visual recording, audio recording, or positioning of the household appliance 112 and automatically register the household appliance 112 without additional steps form the user. In other words, the user could point their immersive reality device 14 toward the household appliance 112 or otherwise select the household appliance 112 in order to register the household appliance 112.

The immersive reality device 14 can further be used to indicate to the user how to load consumables into the household appliance 112. As used herein, the term “consumables”, or iterations thereof, can refer to any element that is needed for the operation of the household appliance 112, and that has a predefined life cycle such that the consumable needs to be replaced once its life cycle is complete. As a non-limiting example, consumables can include, but are not limited to, detergent, soap, water, water filters, carbonated gas cylinders, or any combination thereof. The immersive reality device 14 can be used to indicate to the user, through the immersive reality view 144 and the computer-generated elements 146, that the consumable has reached the end of its life cycle and needs to be replaced. As a non-limiting example, the consumable can be a water filter. The immersive reality device 14 could determine that the end of the life cycle for the water filter has been reached and indicated to the user that that the water filter needs to be replaced. The determination that the end of the life cycle has been reached can be done through communication, via the set of receiving components 16, between the immersive reality device 14 and the household appliance 112. As a non-limiting example, the immersive reality device 14 could display to the user instructions on how to replace a used consumable, access a compartment that holds the consumables, or how to replace the consumable. As a non-limiting example, the consumable can be detergent. The immersive reality device 14 could be used to provide instructions to the user as to how to replace or fill detergent within the household appliance 112 in order to ensure the household appliance 112 can function as intended. It is further contemplated that the immersive reality device 14 could be used to purchase consumables for the household appliance 112. As a non-limiting example, the immersive reality device 14 could determine that additional consumables are needed. If the user does not have the consumables already, the immersive reality device 14 can provide recommended consumables to the user alongside vendors, stores, or retailers who sell the needed consumables. The user could then be directed to a store page or a physical store to buy the needed consumables. Alternatively, the immersive reality device 14 could automatically purchase the consumables. The purchased consumables could be shipped directly to the user for use within the household appliance 112.

It is contemplated that the need for consumables could be determined through the set of receiving components 16 or through memory (e.g., memory 26). As a non-limiting example, the user could point the immersive reality device 14 toward the location where the consumables are stored. If the immersive reality device 14 determines that there are not enough consumables for the household appliances 112 to function properly, then the immersive reality device 14 could indicate to the user that more consumables are needed or required to be purchased. As another non-limiting example, the user could load a portion of the consumables into the household appliance 112 and use the immersive reality device 14 to determine if enough consumables have been used. If it is determined by the immersive reality device 14 that enough consumables have not been used for the household appliance 112 to properly function, then the immersive reality device could recommend more consumables be used or otherwise purchased if the user does not have enough on hand. Conversely, if the user uses too many consumables, the immersive reality device 14 could indicate to the user that they are using too many consumables and recommend that they remove at least a portion of the consumables. As another non-limiting example, the immersive reality device 14 could access memory to determine if a consumable needs to be replaced or otherwise purchased. For example, data relating to at least one of the installation date, use date, purchase date, life cycle, and quantity of the consumable could be stored within memory accessible to the immersive reality device 14. As a non-limiting example, the user could purchase a package of consumables with 30 consumables total. Each time the household appliances 112 is operated, it can require one consumable. As such, the immersive reality device 14 could determine that the consumable needs to be replaced once the household appliance 112 is at or nearing 30 uses since the consumable was purchased.

As yet another non-limiting example, the immersive reality device 14 can further be used to provide step-by-step instructions or guidance for how to access at least a portion of the household appliance 112 for routine maintenance of the household appliance 112. Accessing at least a portion of the household appliance 112 can include, but is not limited to, opening, removing or moving a portion of the household appliance 112 (e.g., opening a door, opening a drawer, opening a cabinet, removing a shelf, moving an element from within, etc.) to expose the portion of the household appliance 112, removing the portion of the household appliance 112 from a remainder of the household appliance 112, or any combination thereof. The routine maintenance can be any suitable routine maintenance such as, but not limited to, cleaning the household appliance 112 or replacing a consumable. As a non-limiting example, the immersive reality device 14 can display computer-generated elements 146 through the immersive reality view 144 that walk the user through the steps or otherwise provide guidance of cleaning the household appliance 112. In order to clean the household appliance 112, it can be required to access (e.g., remove, open, or otherwise expose) portions of the household appliance 112. As a non-limiting example, the computer-generate elements 146 can indicate to the user that they need to open a door, remove a shelf, remove the portion of the household appliance 112 from the remainder of the household appliance 112, expose the portion of the household appliance 112 (e.g., an ice tray), move an element from within or otherwise around the household appliance 112 (e.g., move food, dishes, utensils, etc. from within the household appliance 112), or any other suitable operation needed to be performed by the user in order to aces the portion of the household appliance 112. The computer-generated elements 146 could then provide instructions to the user on how to clean the portion of the household appliance 112 that they have accessed. As a non-limiting example, the computer-generated elements 146 can indicate to the user which cleaning agent needs to be used to clean the portion of the household appliance 112 or ow to physically clean the portion of the household appliance 112. Once the routine maintenance is finished, the immersive reality device 14 can display computer-generated elements 146 that walk the user through the steps or process of reinstalling the portion of the household appliance 112 that the routine maintenance was performed on or otherwise how to reassemble the household appliance 112 to ensure that it operates as intended (e.g., reinstall a shelf that was removed, close a door that was opened, etc.).

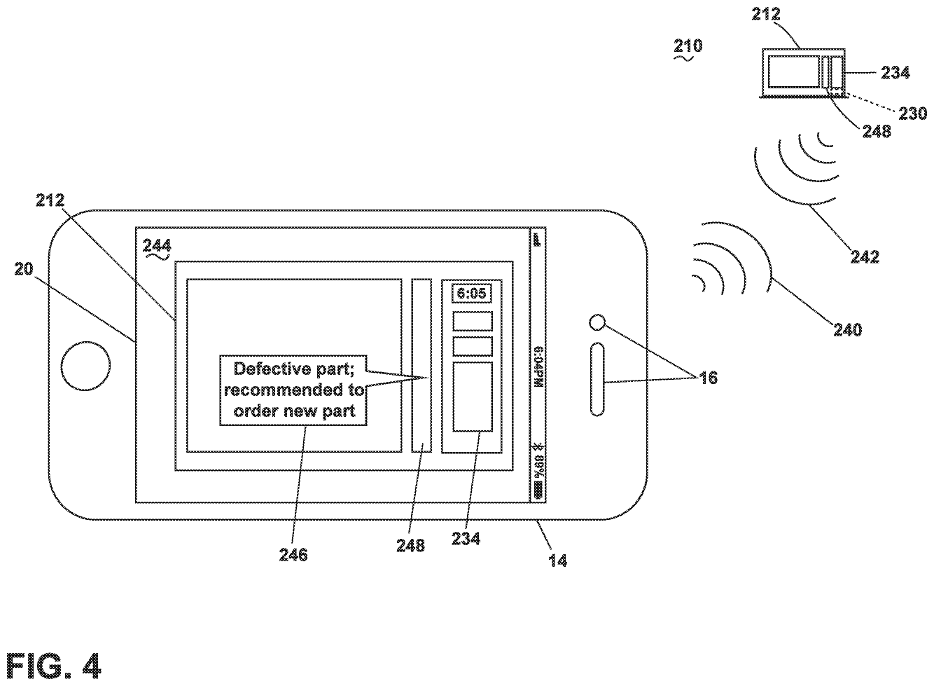

FIG. 4 is a schematic representation of an exemplary immersive reality view 244 on the immersive reality device 14 of FIG. 1. The exemplary immersive reality view 244 is similar to the immersive reality view 44, 144; therefore, like parts will be identified with like numerals in the 200 series, with it being understood that the description of the like parts of the immersive reality view 44, 144 applies to the exemplary immersive reality view 244 unless otherwise noted.

The immersive reality view 244 is similar to the immersive reality view 44, 144 in that it includes a set of computer-generated elements 246 corresponding to a household appliance 212 within an environment 210. As illustrated, the household appliance 212 is a microwave similar to the household appliance 112. It will be appreciated, however, that the household appliance 212 as described herein can be any suitable household appliance 212.

The household appliance 212 can include an HMI including a keypad 234, along with a faulty component 248. As a non-limiting example, the household appliance 212 can include a broken door handle. As such, the household appliance 212, however, can be further defined as a malfunctioning, broken, or faulty household appliance 212. The faultiness of one or more components of the household appliance 212 can be included within the second set of characteristics for the household appliance 212.

In operation, the immersive reality device 14 can detect that the household appliance 212 includes the faulty component 248 and display the faulty component within the immersive reality view 244. The computer-generated element 246 can further be included highlighting or pointing toward the faulty component 248 to indicate to the user that a fault has occurred and where the fault has occurred. The immersive reality device 14 can detect the fault through either visual or audio recordings through a first communication 240 with the environment 210. As a non-limiting example, the immersive reality device 14 can capture a visual recording of the household appliance 212 and determine that the fault has occurred due to a visual aspect of the household appliance 212. For example, the immersive reality device 14 can detect that a crack, break, or other fault has occurred with the faulty component 248 and notify the user on the immersive reality view 244. It is contemplated, however, that the fault can be communicated to the immersive reality device 14 through a second communication 242. For example, if a fault has occurred, the HMI can detect the fault and use the communication component to indicate to the immersive reality device 14, through the second communication 242, that the fault has occurred. In some instances, the fault can be visible from an exterior of the household appliance 212, however, other times the fault can occur within the household appliance 212 and thus not be visible from the exterior. In such a case, the HMI 30 can communicate the faults within the household appliance 212 to the immersive reality device 14. A computer-generated element 246 can then be displayed on the immersive reality view that indicates the fault has occurred, where the fault has occurred, and what the fault is. In any case, the fault can be determined or received by the immersive reality device 14 and displayed on the immersive reality view 244.

The audio pattern and the visual pattern generated by the HMI 230 can be picked up in the audio recordings and the visual recordings, respectively, by the set of receiving components 16. These audio and visual patterns can be generated by a pre-determined set of audio and visual patterns. In other words, if a fault has occurred within the household appliance 212 and the household appliance 212 needs to communicate the fault to the user of the immersive reality device 14, the household appliance 212 may access a look-up table (accessible through internal or external memory) with pre-determined audio and visual patterns based on certain faults and reproduce the audio or visual patterns based on whichever fault has occurred. The immersive reality device 14 can then receive these audio or visual patterns via the set of receiving components 16 and compare them to the same look-up table that is accessible through the memory 26 or another memory. The comparison can be done to determine which fault has occurred. Ultimately, the fault that has occurred can be displayed to the user on the immersive reality view 244 via the computer-generated elements 246.

The computer-generated element 246 can further supply a recommendation to the user on how to fix the fault. This recommendation can be based on the type of and severity of the fault. As a non-limiting example, the computer-generated element 246 can recommend that the user order a new part. Alternatively, the computer-generated element 246 can recommend that maintenance be called or a new household appliance 212 to replace the current one be bought. It is further contemplated that in some cases, a set of instructions can be displayed through the computer-generated elements 246, similar to the instructions of the immersive reality view 144, on how to fix the faulty part, how to order a replacement part, how to order to replacement household appliance 212, or who to call for maintenance. Alternatively, the immersive reality device 14 could automatically order a new part, order a replacement household appliance 212 or call maintenance. It is further contemplated that the immersive reality device 14 can automatically request maintenance from an authorized service center (e.g., a maintenance personal with prior authorization to perform maintenance on the household appliance 212) once the need for maintenance has been established (e.g., the fault has been detected). The authorized service center can receive, from the immersive reality device 14, information relating to the fault. The information can include, but is not limited to, a general description of the fault (e.g., a date the fault occurred, the type of fault, the location of the fault, etc.), the recommended remedy to fix the fault, the needed parts to fix the fault, the steps to fix the fault, the location of the household appliance, contact information for the owner of the household appliance 212, or any combination thereof. With this information, the authorized service center can order the needed parts, assign worktimes, or otherwise prepare to fix the fault.

It will be appreciated that the maintenance instructions supplied to the user through the immersive reality view 244 are not limited to the faulty components 248 as illustrated. As a non-limiting example, the faulty components 248 can further be defined as a component that is causing the household appliance 212 to not operate at peak operating capacity. For example, the household appliance 212 could be a laundry dryer and the faulty component 248 could be a filter that needs to be cleaned or replaced. The immersive reality device 14 could recognize, via the set of receiving components 16, the need for faulty component 248 (e.g., the filter) to be cleaned or replaced and display computer-generated elements 246 on the immersive reality view 244 providing a step-by-step tutorial for the user on how to find the filter, how to clean the filter, and how to reinstall the filter so the household appliance 212 can be used. Other non-limiting examples of faulty components 248 that the immersive reality device 14 could identify and create computer-generated elements 246 for include, but are not limited to, changing the height of the shelves, replacing a water filter, replacing a carbonated gas cylinder, filling a water reservoir, replacing a High-Efficiency Particulate Air (HEPA) filter, cleaning a HEPA filter, or any combination thereof.

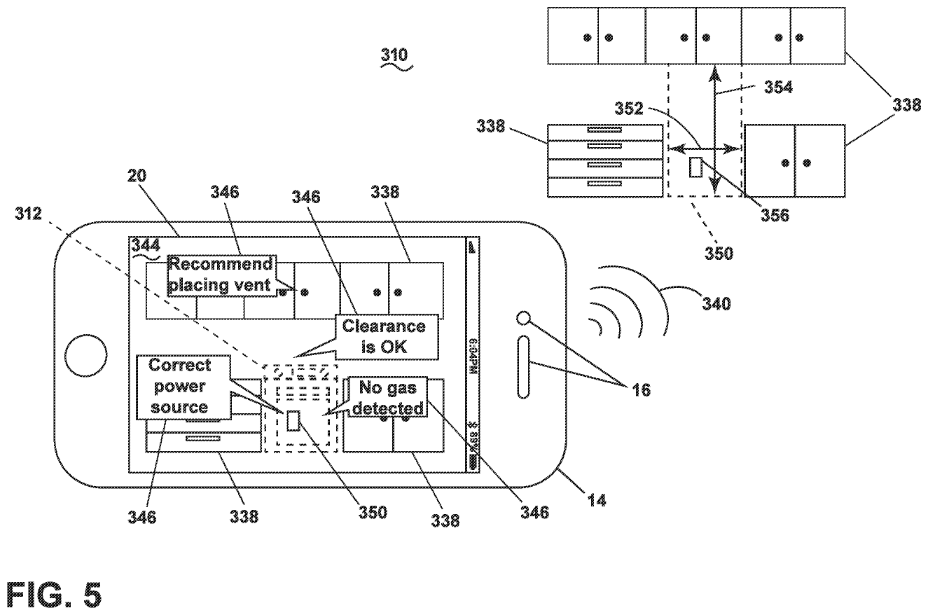

FIG. 5 is a schematic representation of an exemplary immersive reality view 344 on the immersive reality device 14 of FIG. 1. The exemplary immersive reality view 344 is similar to the immersive reality view 44, 144, 244; therefore, like parts will be identified with like numerals in the 300 series, with it being understood that the description of the like parts of the immersive reality view 44, 144, 244 applies to the exemplary immersive reality view 344 unless otherwise noted.

The immersive reality view 344 is similar to the immersive reality view 44, 144, 244 in that it includes a set of computer-generated elements 346. However, the immersive reality view 344 includes a virtual household appliance 312 within an environment 310 and including the same second set of characteristics as if it were a real household appliance. As illustrated, the household appliance 312 is an oven. It will be appreciated, however, that the virtual household appliance 312 as described herein can be any suitable virtual household appliance 312.

The environment 310 can be defined by the set of first characteristics. As illustrated, the environment 310 can include a void 350 between adjacent non-appliance elements 338 or other household appliances (not illustrated). The void 350 can be defined by a height 352 between a floor, a household appliance, or a non-appliance element 338, and a vertically displaced a ceiling, a household appliance, or a non-appliance element 338. The void can be further defined by a width 354 between non-appliance elements 338, household appliances, or walls, and adjacent non-appliance elements 338, household appliances, or walls. The height 352 and the width 354 can, together, define the total space available for a household appliance. The environment 310 can further include other elements necessary for the use of the household appliances in order to meet the functional limitations such as a power source 356. It will be appreciated, however, that the environment 310 can include any other suitable elements such as, but not limited to, power outlets or sources, drains, gas outlets, vents, or any combination thereof. The household appliances, the non-appliance elements, the void 350, the power source 356, and any other elements within the environment can, together, define at least a portion of the set of first characteristics. The immersive reality device 14 can gather the set of first characteristics, via the set of receiving components 16, and display them on the immersive reality view 344. The other elements of the environment 10 can further be defined as elements within the environment for satisfying at least a portion of the functional limitations of the household appliance 312.

A user can select virtual household appliances 312 through the user of the immersive reality device 14. As a non-limiting example, the immersive reality device 14 can include the immersive reality application, which can include a menu of various household appliances, each including their own second set of characteristics. A user can select whichever household appliance they want and have it displayed on the immersive reality view 344 as the virtual household appliance 312 with its corresponding second set of characteristics. It is contemplated that the user can use their immersive reality device 14 and the receiving components 16 on their immersive reality device 14 to capture a household appliance in a separate environment from the environment 310. The user can then project the virtual household appliances 312 within the environment 310 through use of the immersive reality view 344. Examples of separate environments can include, but are not limited to, retail stores, online stores, posters, magazines, newspapers, restaurants, another user's household, a catalog, an online database, a different room of the user's household, or any combination thereof. In some cases, the environment 10 might not be a physical location but instead a database (e.g., an online database) or a picture (e.g., a catalog). As a non-limiting example, the immersive reality device 14 can obtain the second set of characteristics of the household appliance 312 from a non-physical location.

In operation, the user can select at least one household appliance that they would like to have placed within the void 350. As a non-limiting example, the user could select multiple household appliances or non-appliances elements that they would like to have placed within the void 350 (e.g., the user could select a stove with an accompanying vent that would be placed within the void, or a washer and a dryer with the dryer being placed on top of the washer). The immersive reality device 14 can then simulate the virtual household appliances 312 within the void 350 on the immersive reality view 344 and simulate to the user how the virtual household appliance 312 would look in the environment 310 if the real, physical household appliance corresponding to the virtual household appliance 312 were placed within the void 350. The user can then decide on whether or not they would like to buy the household appliance based on the immersive reality view 344. It is further contemplated, however, that the immersive reality view can user the computer-generated elements 346 to aid in the user's decision on whether or not to buy the household appliances. The immersive reality device 14 can analyze the first set of characteristics and determine whether or not the virtual household appliances 312 would be a good fit for the environment 310. This determination could be done by comparing the first set of characteristics with the second set of characteristics of the selected virtual household appliance 312. The determination can further include the determination of whether or not one or more functional limitations of the virtual household appliance 312 would be suitable for the given void 350). As such, the computer-generated elements 346 can be further based on one or more functional limitations of the virtual household appliance 312. These functional limitations can be displayed within the immersive reality view 344.

As a non-limiting example, if the virtual household appliance 312 requires a 120V power or energy source, and the immersive reality device 14 determines that the power source 356 can fulfil this demand, a computer-generated element 346 can be generated telling the user that the power source 356 is correct. If, on the other hand, the virtual household appliance 312 would require a gas line to operate and no gas line is detected in the environment 310, then a computer-generated element 346 could be made telling the user that the virtual household appliance 312 is unfit for, or would not work in the void 350 of the environment 310. Further yet, computer-generated elements 346 can be made based on the how the second set of characteristics would act if they were within the environment.

It is contemplated that a computer-generated element 346 could be made telling the user that the virtual household appliance 312 would fit within the void 350 and that the clearance between the household appliance 312 and adjacent elements within the environment 310 is okay. However, since the user had selected an oven, which gives off heat and might create smoke when cooking, the virtual household appliance 312 might not be suitable for the void 350 based on how it would interact with adjacent elements. For example, if it was determined that there was no venting directly above where the household appliance 312 would be, a computer-generated element 346 could be made pointing this out to the user. As a non-limiting example, the computer-generated element 346 could indicate that venting is required. In yet another non-limiting example, the first set of characteristics can include a material of the elements (e.g., the household appliances, the non-appliance elements 338, etc.) within the environment. If the immersive reality device 14 determines that an operational characteristic (e.g., a heat, a humidity, etc.) of the virtual household appliance 312 would be unfit for the material and cause failure of the material, a computer-generated element 346 coupled be generated informing the user of the fact. If it is determined that the virtual household appliance 312 would be a good fit within the void 350 of the environment 310, then the immersive reality device 14 could recommend to the user that they should buy the household appliances corresponding to the virtual household appliance 312. Alternatively, the immersive reality device 14 could automatically buy the corresponding household appliance 312. Further, if the virtual household appliance 312 is unfit for the void 350 or the environment 310, then the immersive reality device 14 could recommend to the user that they should not buy the household appliance corresponding to the virtual household appliance 312, recommend a suitable household appliances, or otherwise recommend alterations to the environment (e.g., installing a vent and a gas line) that would allow for the virtual household appliances to work within the environment. Alternatively, the immersive reality device 14 could automatically buy a household appliance that would work within the void 350 of the environment 310.

It is yet further contemplated that in the cases where the user points their immersive reality device 14 toward the void 350 that the immersive reality device 14 could automatically chose a virtual household appliance 312 that would be suitable for the void 350, without the user having to first select the virtual household appliance 312. In other words, the user could point one or more receiving components 16 toward the void 350, and the immersive reality device 14 could automatically come up with a singular household appliance or a list of household appliances that would fit within the void 350. Each household appliance could then be displayed on the immersive reality view 344 as the virtual household appliance 312 to the user, who could then choose which of the virtual household appliances 312 they would like to purchase. In some cases, the user can select the type of household appliance they want, and the immersive reality device could present suitable household appliances to the user.

Further yet, it will be appreciated that the environment 310 as displayed on the immersive reality view 344 can include any number of virtual elements (e.g., not within the environment 310 as a physical element) or non-virtual elements (e.g., already within the environment as a real-world element). As a non-limiting example, the entirety of the immersive reality view 344 an be virtual and the user can select which virtual household appliances 312 and virtual non-appliances elements 338 they wish to position within the environment 310. This can allow for the user to construct entire virtual environments 310 on their immersive reality device 14 and clearly visualize how the environment 310 would look with these elements. Further yet, it will be appreciated that that the immersive reality view can be used to simulate capacity limitations of a virtual or non-virtual household appliance 312. As a non-limiting example, a user could open a virtual or non-virtual refrigerator and use the immersive reality view 344 to simulate objects (e.g., pizza, milk, eggs, etc.) being placed within the refrigerator. This can allow for the user to make a more informed decision when it comes to buying the household appliance 312 as the user can determine the practicality of the household appliance 312 before buying.

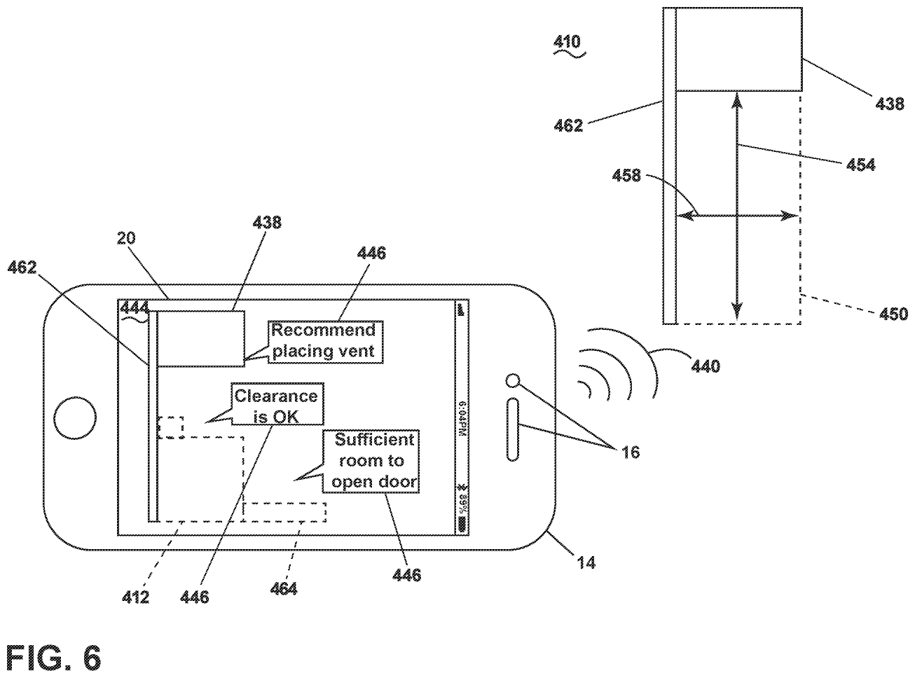

FIG. 6 is a schematic representation of an exemplary immersive reality view 444 view on the immersive reality device 14 of FIG. 1. The exemplary immersive reality view 444 is similar to the immersive reality view 44, 144, 244, 344; therefore, like parts will be identified with like numerals in the 400 series, with it being understood that the description of the like parts of the immersive reality view 44, 144, 244, 344 applies to the exemplary immersive reality view 444 unless otherwise noted.

The immersive reality view 444 is similar to the immersive reality view 344 in that it includes a set of computer-generated elements 446 for a corresponding virtual household appliance 412 that can be positioned within a void 450 of an environment 410. The void 450 can be defined by a height 454 between the floor and a non-appliance element 438. The void 450 can further be defined by a depth 458 between a wall 462 and a boundary set by the depth of the virtual household appliance 412. As illustrated, the household appliance 412 is an oven similar to the virtual household appliance 312. It will be appreciated, however, that the virtual household appliance 412 as described herein can be any suitable virtual household appliance 412.

The immersive reality view 444 can include the computer-generated element 446 similar to the computer-generated elements 346 as they can include prompts to the user that the clearance is okay, the virtual household appliance 412 would fit within the void 450, or recommendations (e.g., place a vent directly above the void 450). As illustrated, the immersive reality view 444 could simulate one or more functional limitations of the virtual household appliance 412 based on the environment 410. As a non-limiting example, the immersive reality view 444 could simulate a door 464 of the virtual household appliance 412 opening and simulate its effect on the surrounding environment. As illustrated, the door 464 has sufficient room to open, thus a computer-generated element 446 is created stating that there is sufficient room. The visualization of the functional limitations of the virtual household appliance 412 can aid the user in deciding if the virtual household appliance is suitable for their environment 410.

It is contemplated that the user can access the functional limitations or actuate the functional limitations of the virtual household appliance 412 through any suitable method. As a non-limiting example, there user of the immersive reality device 14 could physically touch, on the user interface 20, the portion of the virtual household appliance 412 that corresponds to at least one functional limitation in order to actuate the functional limitation. For example, the user could touch the front of or the handle of the virtual household appliance 412 in order to open or close the door 464. Alternatively, the user could use any suitable method such as, but not limited to, voice commands, pointing, turning towards, positioning the immersive reality device 14, selection within a menu on the immersive reality device, physical touch, or any combination thereof.

Although only the opening/closing of the door 464 is illustrated, it will be appreciated that any suitable functional limitation of the virtual household appliance 412 could be actuated. As a non-limiting example, the user could turn on one or more burners on the virtual household appliance 412 in order to see how the heat emitted from the virtual household appliance 412 would interact with the environment 410. On a same note, the user could simulate the cooking of a food item through the virtual household appliance 412. It will be further yet appreciated that the simulation of the functional limitations is not constrained solely to the virtual household appliance 412. As a non-limiting example, the user could simulate a functional limitation of a real household appliance (e.g., the household appliance 12, 112, 212) that is already present within the environment. The simulation of the functional limitations can be the simulation of any functional limitation of the respective virtual or non-virtual household appliance through the immersive reality view 444.

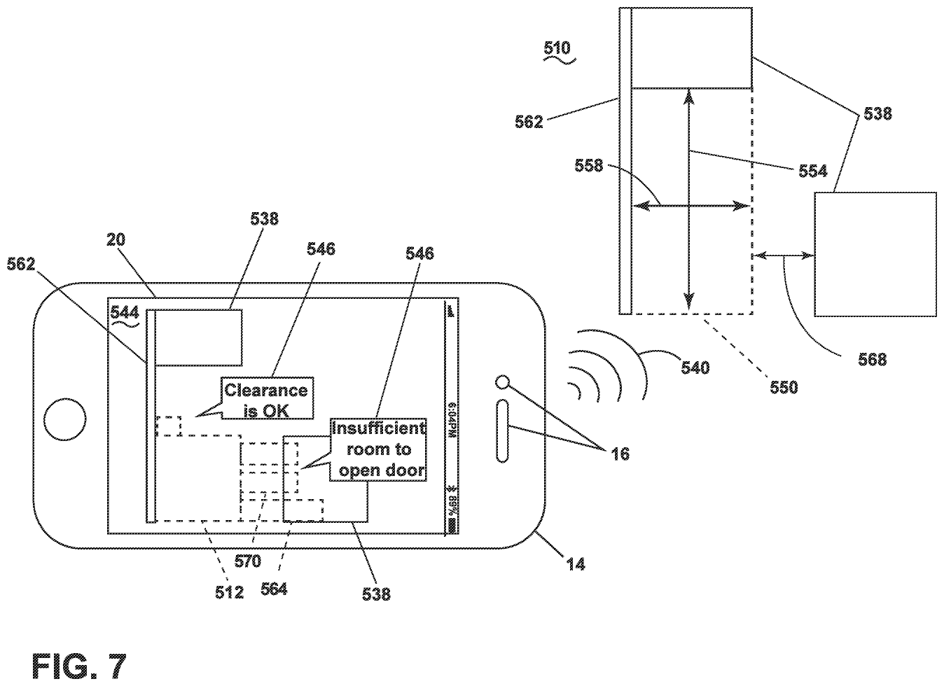

FIG. 7 is a schematic representation of an exemplary immersive reality view 544 on the immersive reality device 14 of FIG. 1. The exemplary immersive reality view 544 is similar to the immersive reality view 44, 144, 244, 344, 444; therefore, like parts will be identified with like numerals in the 500 series, with it being understood that the description of the like parts of the immersive reality view 44, 144, 244, 344, 444 applies to the exemplary immersive reality view 544 unless otherwise noted.

The immersive reality view 544 is similar to the immersive reality view 344, 444 in that it includes a set of computer-generated elements 546 for a corresponding virtual household appliance 512 that can be positioned within a void 550 of an environment 510. The void 550 can be defined by a height 554 between the floor and a non-appliance element 538. The void 550 can further be defined by a depth 558 between a wall 562 and a boundary set by the depth of the virtual household appliance 512. An additional non-appliance element 538 can be displaced a distance 568 from the void 550 in the direction of the depth 558. The additional non-appliance element 538 can be any suitable non-appliance element 538 such as, but not limited to, a table, a chair, a bench, a sofa, an island, a counter, a drawer, a cabinet, a pantry, or any combination thereof. As illustrated, the household appliance 512 is a dishwasher. It will be appreciated, however, that the virtual household appliance 512 as described herein can be any suitable virtual household appliance 512.

The immersive reality view 544 can include the computer-generated element 446 similar to the computer-generated elements 346, 446 as they can include prompts to the user that the clearance is okay, the virtual household appliance 512 would fit within the void 550, or recommendations (e.g., place a vent directly above the void 550). As illustrated, the immersive reality view 544 could further simulate one or more functional limitations of the virtual household appliance 512 based on the environment 510, similar the immersive reality view 444. As a non-limiting example, the immersive reality view 544 can simulate the opening/closing of a door 564. The immersive reality view 544 can further simulate the opening/closing or actuation of one or more elements from within the virtual household appliance 512. As a non-limiting example, the immersive reality view 544 can simulate the opening/closing of a set of dishracks 570 from within the virtual household appliance 512.

As illustrated, the door 564 and the dishracks 570 do not have sufficient room to open as they would come into contact with the non-appliance element 538. In other words, the distance 568 between the void 550 and the non-appliance element 538 is not large enough, thus if the household appliance corresponding to the virtual household appliance 512 were placed within the void 550, there would not be sufficient room for the functional limitations of the household appliance. One or more computer-generated element 546 can be generated to inform the user that there is insufficient room. Another computer-generated element 546 could be generated to recommend to the user how to solve this issue. For example, computer-generated elements 546 could be created recommending a new household appliance to choose from or recommend alterations to the body that the virtual household appliance 512 impinges (e.g., the non-appliance element 538, as illustrated).

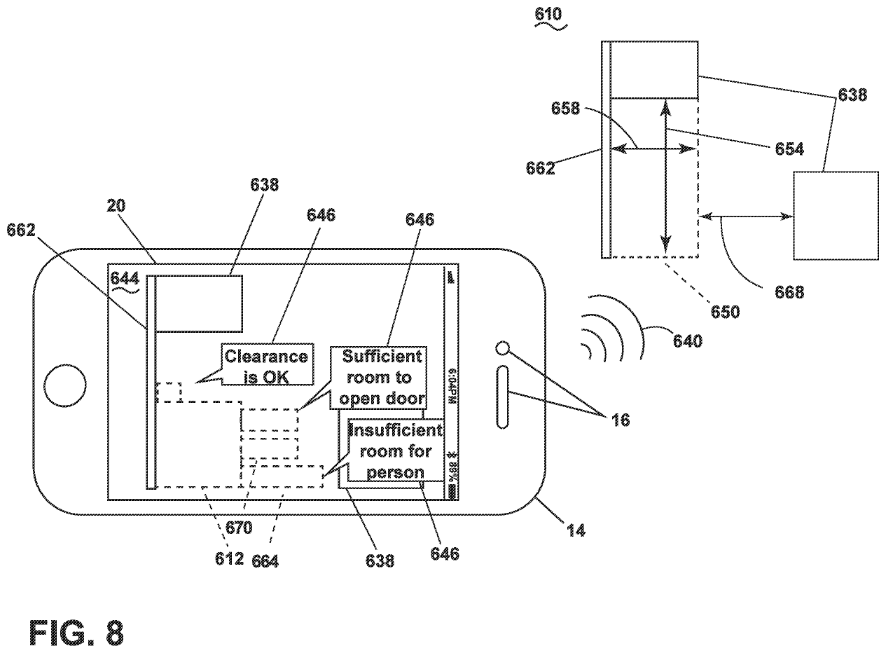

FIG. 8 is a schematic representation of an exemplary immersive reality view 644 on the immersive reality device 14 of FIG. 1. The exemplary immersive reality view 644 is similar to the immersive reality view 44, 144, 244, 344, 444, 544; therefore, like parts will be identified with like numerals in the 600 series, with it being understood that the description of the like parts of the immersive reality view 44, 144, 244, 344, 444, 544 applies to the exemplary immersive reality view 644 unless otherwise noted.

The immersive reality view 644 is similar to the immersive reality view 344, 444, 544 in that it includes a set of computer-generated elements 646 for a corresponding virtual household appliance 612 that can be positioned within a void 650 of an environment 610. The void 650 can be defined by a height 654 between the floor and a non-appliance element 638. The void 650 can further be defined by a depth 658 between a wall 662 and a boundary set by the depth of the virtual household appliance 612. An additional non-appliance element 638 can be displaced a distance 668 from the void 650 in the direction of the depth 658. This configuration is similar to that of FIG. 7, however, it will be appreciated that the distance 668 is larger than the distance 568, or the total space needed for the functional limitations of the virtual household appliance 612 is smaller than the total space needed for the functional limitations of the virtual household appliance 512. As illustrated, the household appliance 612 is a dishwasher similar to the virtual household appliance 512. It will be appreciated, however, that the virtual household appliance 612 as described herein can be any suitable virtual household appliance 612.

The immersive reality view 644 can include the computer-generated element 646 similar to the computer-generated elements 346, 446, 546 as they can include prompts to the user that the clearance is okay, the virtual household appliance 612 would fit within the void 650, or recommendations (e.g., place a vent directly above the void 650). As illustrated, the immersive reality view 644 could further simulate one or more functional limitations of the virtual household appliance 612 based on the environment 610, similar the immersive reality view 444, 544. As a non-limiting example, the immersive reality view 644 can simulate the opening/closing of a door 664 and the opening/closing of a set of dishracks 670.

As illustrated, there is sufficient room for the functional limitations of the virtual household appliance 612, thus the computer-generated element 646 can be generated to inform the user of such. The total amount, however, that the functional limitations use or span across the distance 668 might not leave enough room for routine activities to occur on the non-appliance element 638 when the functional limitations are activated (e.g., the door 664 is opened). As a non-limiting example, if the door 664 is opened, there might not be enough space between the distal end of the door 664 and the non-appliance element 638 for a person to freely pass by or to user the non-appliance element 638. In such a case, the computer-generated element 646 can be generated highlighting the space between the distal end of the functional limitation and the adjacent non-appliance element 638 to inform the user that there is insufficient space for a person. Additional computer-generated elements 646 can then be generated to help the user in deciding whether or not they would like to purchase the household appliance corresponding to the virtual household appliance 612. As a non-limiting example, computer-generated elements 646 could inform the user exactly how much space is available between the distal end of the functional limitations and the non-appliance element 638.

As yet another non-limiting example, computer-generated elements 646 could generate a prompt asking the user if they were okay with their selection of the virtual household appliance 612, even considering the functional limitations. If the user is okay with their selection, they could indicate as much through the prompt. The immersive reality device 14 could then forward the user to a retailer's website or an address of a retailer in order to buy the household appliance corresponding to the virtual household appliance 612. Alternatively, the immersive reality device 14 could automatically purchase the household appliance if the user indicates through the prompt that they are ok with their selection. If the user were to indicate through the prompt that they were not okay with the selection, then the immersive reality device 14 could present options of alterative virtual household appliances 612 that are better suited for the environment 610. Alternatively, the immersive reality device 14 could automatically purchase a household appliance that would be better suited for the environment 610.

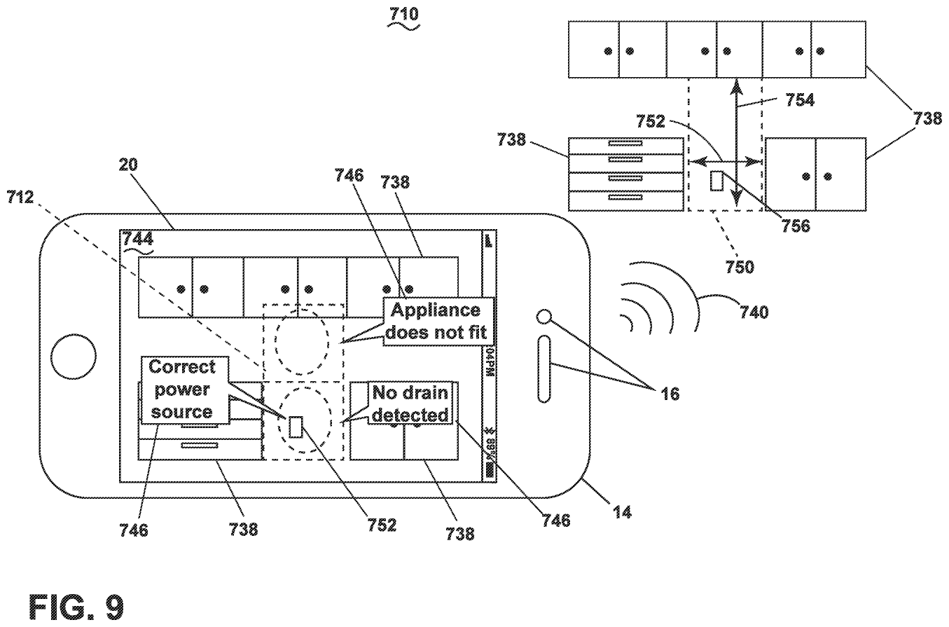

FIG. 9 is a schematic representation of an exemplary immersive reality view on the immersive reality device of FIG. 1. The exemplary immersive reality view 744 is similar to the immersive reality view 44, 144, 244, 344, 444, 544, 644; therefore, like parts will be identified with like numerals in the 700 series, with it being understood that the description of the like parts of the immersive reality view 44, 144, 244, 344, 444, 544, 644 applies to the exemplary immersive reality view 744 unless otherwise noted.

The immersive reality view 744 is similar to the immersive reality view 344, 444, 544, 644 in that it includes a set of computer-generated elements 746 for a corresponding virtual household appliance 712 that can be positioned within a void 750 of an environment 710. The void 750 can be defined by a width 752 and a height 754. The void 750 can be surrounded by non-appliance elements 738 or household appliances. The environment 710 can further include other elements necessary for the use of the household appliances such as a power source 756. As illustrated, the household appliance 712 is a washer and a dryer. It will be appreciated, however, that the virtual household appliance 712 as described herein can be any suitable virtual household appliance 712.

The immersive reality view 744 can simulate the virtual household appliance 712 within the void 750, and include similar computer-generated elements 746 to the immersive reality view 344. As a non-limiting example, the computer-generated element 746 could indicate to the user that the power source 756 is correct for the virtual household appliance 712. However, as the virtual household appliance 712 can require a drain, or a vent, the computer-generated elements 746 could inform the user that a drain or a vent was not detected. As illustrated, the virtual household appliance 712 is also too big for the void 750. If a user were to install a household appliance corresponding the virtual household appliance 712, it would not fit within the void 750. The computer-generated elements 746 could inform the user that the virtual household appliance 712 does not fit. Additional computer-generated elements 746 can then be generated to help the user in deciding whether or not they would like to purchase the household appliance corresponding to the virtual household appliance 712. In the present case, the computer-generated elements 746 can recommend not buying the virtual household appliance 712 as a drain would need to be installed and the void 750 would need to be made larger. It is contemplated that the immersive reality device 14 could generate additional computer-generated elements 746 indicating an alternative household appliance that would fit within the void 750. Alternatively, the immersive reality device 14 could forward the user to a retail website, a retail shop, or otherwise automatically purchase the alternative household appliance.

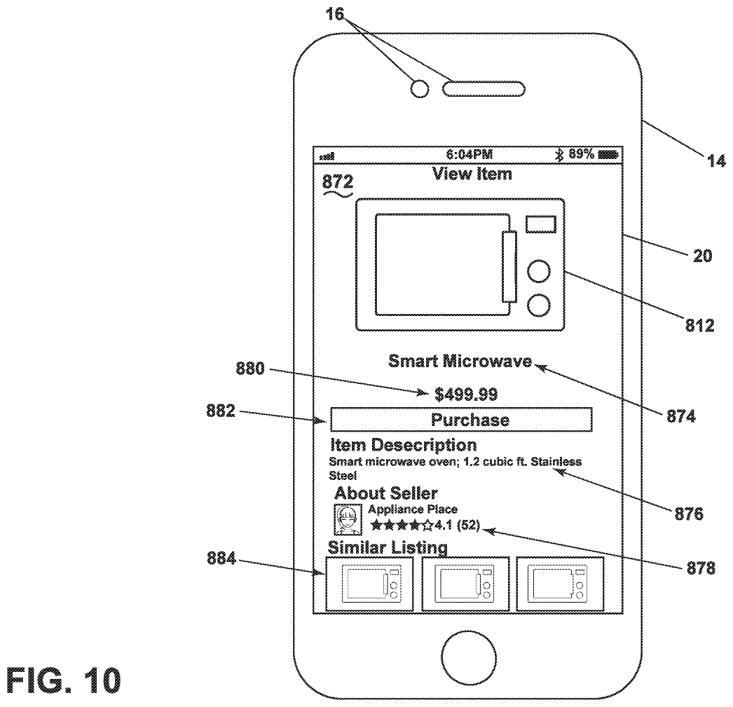

FIG. 10 is a schematic view of the immersive reality device 14 of FIG. 1 illustrating a method of purchasing an exemplary household appliance 812. It will be appreciated that the method disclosed herein for purchasing the household appliance 812 can be done after an immersive reality view (FIGS. 2-9) has been generated and the user has decided which household appliance 812 they wish to purchase. The household appliance 812, as illustrated, is a microwave. However, it will be appreciated that the household appliance 812 can be any suitable household appliance, as described herein, or a portion of the household appliance 812 (e.g., a replacement part for the household appliance 812).

The method, as illustrated, shows a buying user interface (UI) 872. It will be appreciated that the buying UI 872 can be any suitable UI such as, but not limited to, a webpage, or a portion of the immersive reality application (e.g., the application that gives the immersive reality device 14 the immersive reality capabilities). In one non-limiting aspect, the buying UI 872 is viewable to a user who selects a virtual household appliance 312, 412, 512, 612, 712 they wish to purchase. Alternatively, the buying UI 872 is viewable to a user who selects a replacement household appliance or a replacement part for a household appliance. Upon selection of the household appliance (virtual or non-virtual), a virtual representation of the household appliance 812 is displayed. The buying UI 872 can be populated with available household appliance transaction details, for example, delivered from the computing device 22, the immersive reality device 14, the immersive reality application, a webpage, or a combination thereof.

A non-limiting example set of data delivered to the buying UI 872 can include a graphical or pictorial representation of the household appliance 712, and a textual description 874 of the household appliance 812, data or information related to the posting (e.g. “Posted: 1 days ago”) or a quantity of items being offered in the transaction. The buying UI 872 can further include a detailed item description 876 for additional details related to the household appliance 812 or details of the transaction, or a requested price 880 for the household appliance 812. The second set of characteristics of the household appliance 812 can at least partially comprise the buying UI 872. As a non-limiting example, the item description 876 can include a power requirement for the household appliance 812.

The buying UI 872 can further include a “purchase” or “contact seller” button 882, or another mechanism to initiate contact with the seller of the amiable household appliance 812. As anon-limiting example, the button 882 can be used to ask additional questions related to the household appliance 812, negotiate on price or trade, to arrange a pick-up location, or to purchase the household appliance 812. A buying user can further view a retailer summary 878 for the retailer, which for instance can include, but is not limited to, a retailer's photo/logo, name, and a seller rating, represented by a numeric or graphical indication, cumulative ratings number, or the like. In another non-limiting example of the buying UI 872, a grouping of other similar, alternative, or related listings 884 can be presented to the buying user. For example, similar listings 884 of a particular household appliance 812 can include additional available household appliances 812 similar to the currently selected household appliance 812. In another non-limiting example, similar listings 884 can be determined, shown, or included based on a searching or buying user's search history, proximity the retailer, household appliance category, or another determination or filtering-type of determination.

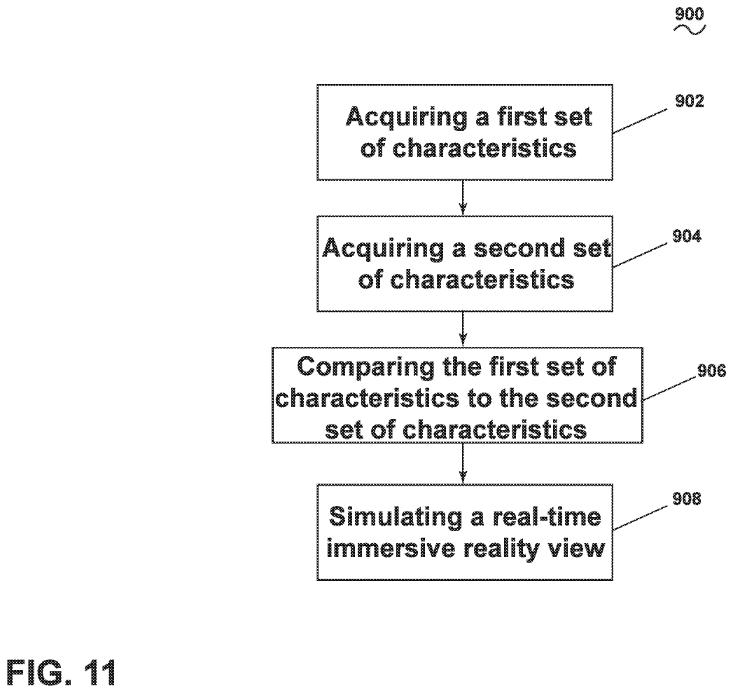

FIG. 11 illustrates a method 900 of implementing the immersive reality view 44 on the immersive reality device 14 of FIG. 1. Reference herein will be made to the immersive reality view 44 and the environment of FIG. 1, however, it will be appreciated that the method 900 can be applied to any suitable immersive reality view 44 or environment 10 as described herein. The method 900 can be used for providing a real-time simulation of one or more functional limitations of an existing or virtual household appliance 12.

The method 900 can begin by acquiring or otherwise detecting the first set of characteristics of the environment 10, at 902. The first set of characteristics can include at least one constraint of the environment 10 such as, but not limited to, a size, a temperature, a humidity, a number of household appliances, a number of non-appliance elements, a distance between adjacent elements (household appliances or non-appliance elements), a material, or any combination thereof. The second set of characteristics associated with the household appliance 12 can be acquired or otherwise detected, at 904. The acquisition of the first set of characteristics and the second set of characteristics can be done through the use of the set of receiving components 16. The first set of characteristics and the second set of characteristics can be gathered, measured, received, or otherwise obtained through at least one of an audio recording, a visual recording, a wireless transmission, a communication between the immersive reality device and the environment 10 or the household appliance 12, or a wired transmission. As a non-limiting example, the second set of characteristics can be acquired by accessing a memory (e.g., memory 26 or a cloud-type storage) containing the second set of characteristics for the respective household appliance 12. The second set of characteristics can comprise a set of operational characteristics of the household appliance. The set of operation characteristics can include, but are not limited to, a status (e.g., “ON” or “OFF”), a thermal emission, a water requirement, a gas requirement, a power requirement, a space requirement for one or more components of the household appliance 12 (e.g., a drawer, a rack, etc.), a fault, a maintenance requirement, an element (e.g., an ice/water dispenser, a user interface, a door handle, etc.), a type, a make, a model number, or a registration number, or any combination thereof.

A comparison between the first set of characters tics and the second set of characters tics can determine one or more limitations of the household appliance 12, at 906. The one or more limitations can include any suitable limitation as described herein. As a non-limiting example, the one or more limitations can include, but are not limited to, an effect on the environment 10 from a heat (e.g., a thermal emission) or humidity emitted from the household appliance 12, the interference of the household appliance 12 with the environment 10 (e.g., a portion of the household appliance 12 contacting a portion of the environment due to the vibration, movement, sound, etc. of the household appliance 12), a determination if a requirement of the household appliance 12 is met by environment 10 (e.g., venting requirements, drain requirements, water requirement, power/energy requirements, performance requirements, gas requirements, etc.), a space requirement such as, but not limited to, or any combination thereof. It will be appreciated that the comparison can be done through any suitable method as described herein. As a non-limiting example, the one or more limitations can be obtained by comparing the first set of characteristics and the second set of characteristics, via the immersive reality device 14, through any suitable method such as, but not limited to, pattern recognition (e.g., an audio or visual pattern), AI provided on or accessible to the immersive reality device 14, an at least partially trained ANN provided on or accessible to the immersive reality device 14, an EDS provided on or accessible to the immersive reality device 14, or any combination thereof. It will be further appreciated that the comparison, which obtains the limitations of the household appliance 12, can be done by performing a functional comparison between the household appliance 12 and the environment 10 perfumed through the use of AI, ANN, or expert diagnostic systems. Alternatively, the limitations of the household appliance 12 can already be known and stored in memory accessible to the immersive reality device 14 such that the comparison can be done by obtaining the limitations of the household appliance 12 from memory accessible to the immersive reality device 14.

The immersive reality view 44 can then be simulated to provide a real-time representation of the household appliance 12 (virtual or non-virtual) within the environment 10, at 908. The simulation can illustrate at least a portion of the limitations, the first set of characteristics, or the second set of characteristics, or a combination thereof.

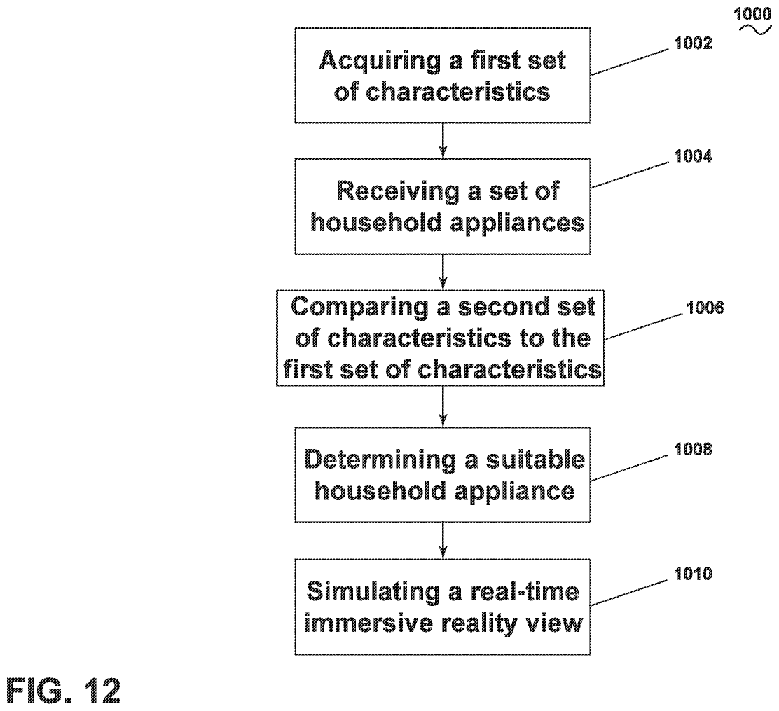

FIG. 12 illustrates an exemplary method 1000 of implementing the immersive reality view 44 on the immersive reality device 14 of FIG. 1. Reference herein will be made to the immersive reality view 44 and the environment of FIG. 1, however, it will be appreciated that the method 1000 can be applied to any suitable immersive reality view 44 or environment 10 as described herein. The method 1000 can be used for selecting a household appliance 12 that would be best suited for the environment 10.

The method 1000 can begin by acquiring or otherwise detecting the first set of characteristics of the environment 10, via the receiving components 16, at 1002 similar to 902. The first set of characteristics comprising at least one constraint of the environment 10. A set of household appliances 12 can be received, at 1004. In other words, the immersive reality device 14 can receive at least one virtual household appliance 12, with each including a respective second set of characteristics. As a non-limiting example, the receiving of the set of household appliances 12 can be done through the audio recording or visual recording or the receiving components 16, or through wireless transmission or wired transmission. The second set of characteristics can include at least one of a thermal emission, a water requirement, a power requirement, a space requirement or a drainage requirement of the household appliance 12. A comparison between the second set of characteristics and the first set of characteristics can be done, at 1006. The comparison can, for example, be used to determine one or more limitations of the virtual household appliance 12 within the environment 10. A determination based on the comparison can be made as to which household appliances 12 of the set of household appliances 12 would be suitable for the environment, at 1008. A simulation of the immersive reality view 44 illustrating on the user interface 20 the determined household appliances 12 of the set of household appliances 12 within the environment, at 1010.

The comparison can compare the second set of characteristics of the household appliance 12 to the first set of characteristics of the environment 10. The comparison can be used to determine if the household appliance 12 would be suitable for is otherwise adapted for use within the environment 10. As a non-limiting example, the comparison can be include comparing the dimensional requirements (e.g., the footprint) of the household appliance 12 within an available space of the environment. As another non-limiting example, the comparison can include comparing the operational parameters corresponding to a heat, humidity, or vibration created by or emitted by the household appliance 12 and its effects on the surrounding elements within the environment 10. For example, the household appliance 12, when operated, can emit a heat that can radiate toward adjacent elements (e.g., a non-appliance element 38 or another household appliance 12) within the household appliance 12. As a non-limiting example, the material of an adjacent element may not be able to sustain the heat emitted by the household appliance 12, or otherwise be damaged by the heat. As the material of the elements within the environment can be included within the first set of characteristics, the comparison can determine if the operation of the household appliance 12 (e.g., the heat emitted by the household appliance 12) would be suitable for a rating (e.g., a temperature rating, a humidity rating, etc.) of at least a portion of surrounding environment 10. In other words, the comparison can be used to determine if the operation of the household appliance 12 would damage the surrounding environment 10 by exceeding one or more ratings of the environment 10. As a non-limiting example, the comparison can be used to determine if a heat emitted by the household appliance 12 during operation of the household appliance 12 would exceed a temperature rating of a portion of the surrounding environment 10. As another non-limiting example, the comparison can be used to determine if various performance requirements of the household appliance 12 would be satisfied within the environment 10. The operation of the household appliance 12, for example, may require a power socket, an ethernet port, a cable line, a WIFI signal/map, a gas line, or a drain in order to operate. The comparison can be used to determine if these operational requirements of the household appliance would be met within the environment 10. As a non-limiting example, the immersive reality device 14 can be sued to determine a WIFI signal or data signal (e.g., cellular data) strength or WIFI or data map. The strength of the data signal or WIFI signal strength could be determined directly by the immersive reality device 14. As a non-limiting example, the immersive reality device 14 can connect to the environment 10 WIFI or data signal and determine if the signal is strong enough or even present in the environment 10 for the household appliance 12. As another non-limiting example, the immersive reality device could create the WIFI map or the data map of the environment 10. The maps could indicate the strength of the WIFI signal or data signal at corresponding portions of the environment 10. As such, the immersive reality device could recommend a location or indicate to the user a location where the household appliance 12 would be best suited based, in part, on the where the WIFI or data signals would be best for the household appliance 12. As another non-limiting example, the comparison can determine the comfort of the user when using the household appliance 12. It is contemplated that the operation of the household appliance 12 can be easier if various elements are provided within the environment to aide in the operation of the household appliance 12. As a non-limiting example, these various elements that can aide in the operation of the household appliance 12 can include, but are not limited to, a light source, a vent, a countertop, a drawer, a cabinet, a power socket, or any combination thereof.

It is contemplated that the comparison, however, is not limited to determining whether or not damage would be caused through the operation of the household appliance 12. As a non-limiting example, the comparison can be used to determine if the physical installation of the household appliance 12 would damage a portion of the environment. For example, a user can use the immersive reality device 14 to determine whether or not the household appliance 12 would damage a portion of the environment 10 if it were placed within the portion of environment, operated within the portion of environment, or otherwise moved through the portion of environment. It is contemplated that a user could use the immersive reality device to simulate moving the household appliance 12 from one place to another, or otherwise moving the household appliance 12 through the environment. As a non-limiting example, the user could simulate moving the household appliance 12 through a doorway within the environment 10. As a non-limiting example, a comparison can be done between the size of the household appliance 12 and the doorway. The determination can then be used to decide if the household appliance 12 could fit through the doorway. It is contemplated that the comparison can also be used to determine if the household appliance can fit through a portion of the environment (e.g., the doorway) through rotation, or tilting of the household appliance 12. For example, a household appliance 12 may not fit through the doorway if it is stood upright, however, it might fit through the doorway if it were tilted and fed through the doorway one end at a time. As such, the simulation could be used to simulate to the user of the immersive reality device 14 the best way to move the household appliance through the environment 10 without damaging any portion of the environment 10.

The method 1000 can be used in instances where the environment 10 includes a void (e.g., void 350, 450, 650, 750) that the user wishes to fill with a suitable household appliance. Alternatively, the method 1000 can be used to simulate the replacement of an existing household appliance 12 with a new household appliance 12. In such a case, the immersive reality view 44 would simulate the new household appliance 12 over, or in place of the existing household appliance 12. In other words, the existing household appliance 12 could define the void in which the virtual household appliance 12 would be placed within on the immersive reality view 44.

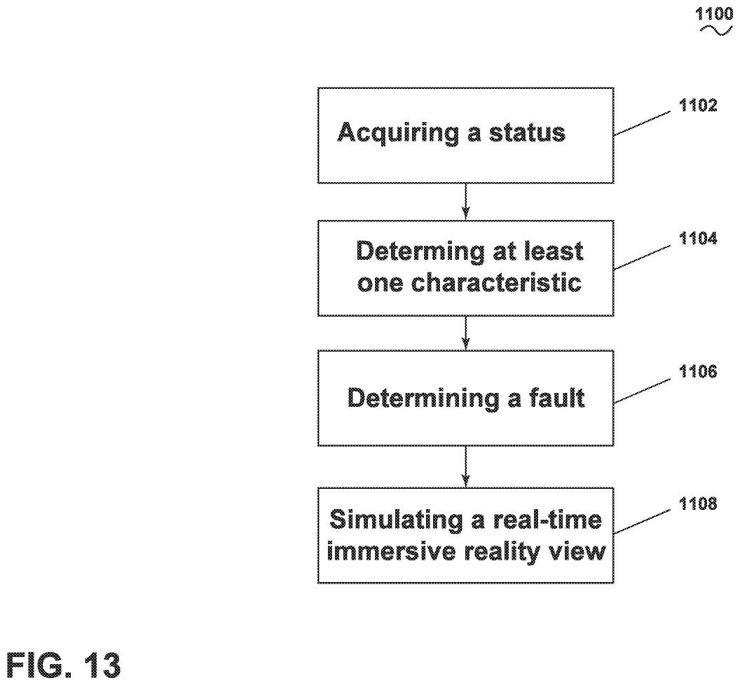

FIG. 13 illustrates an exemplary method 1100 of implementing the immersive reality view 44 on the immersive reality device 14 of FIG. 1. Reference herein will be made to the immersive reality view 44 and the environment of FIG. 1, however, it will be appreciated that the method 1100 can be applied to any suitable immersive reality view 44 or environment 10 as described herein. The method 1100 can be used for diagnosing a household appliance 12 on the immersive reality device 14.

The method 1100 can begin by acquiring a status of the household appliance 12, at 1102. The acquisition of the status can be done by the set of receiving components 16 of the immersive reality device 14. As a non-limiting example, the status of the household appliance 12 can be acquired through an audio recording or a visual recording of the receiving components, as described herein. As another non-limiting example, the status of the household appliance 12 can be acquired through a wireless or a wired data transmission. As a non-limiting example, wireless data transmission can occur by transmitting data from a portion of the household appliance 12 (e.g., a transmitter, a WIFI module, a Bluetooth module, a speaker, the HMI 30, an NFC module, etc.) to at least one of the receiving components 16 of the immersive reality device 14. It will be further appreciated that the acquisition of the status can be done through any other suitable method such as, but not limited to AI provided on or accessible to the immersive reality device 14, an at least partially trained ANN provided on or accessible to the immersive reality device 14, an EDS provided on or accessible to the immersive reality device 14, or any combination thereof. The status can include any suitable status of the household appliance 12 such as a normal operating status (e.g., the household appliance 12 is operating as intended and there is no need for maintenance), a deteriorating operating status (e.g., the household appliance 12 is starting to operate sub-optimally such that some form of maintenance may be needed or otherwise needed in the future), or a faulty operating status (e.g., the household appliance 12 needs maintenance in order to function properly). As used herein, the term “maintenance” or iterations thereof can be defined as a task or set of tasks that are performed on the household appliance in order to put the household appliance 12 into full operating capacity. As a non-limiting example, maintenance can include at least one of, but is not limited to, fixing a fault of the household appliance 12, replacing a component of the household appliance 12, replacing a consumable of the household appliance 12, or any combination thereof.

At least one characteristic of the household appliance 12 can be determined based on the status, at 1104. The at least one characteristic can include at least a portion of the second set of characteristics as described herein. As a non-limiting example, the at least one characteristic can include, but is not limited to, a fault, an error, a need for maintenance, a need to refill or replace at least one consumable, or any combination thereof. With the determined at least one characteristics of the household appliance 12, it can be determined whether or not the at least one audio recording or the at least one visual recording is indicative of a fault associated with the household appliance 12, at 1106. The at least one characteristic can then be simulated on the immersive reality view 44, at 1108.

The sequences depicted are for illustrative purposes only and is not meant to limit the method 900, 1000, 1100 in any way as it is understood that the portions of the method 900, 1000, 1100 can proceed in a different logical order, additional or intervening portions can be included, or described portions of the method can be divided into multiple portions, or described portions of the method can be omitted without detracting from the described method. For example, the method 900, 1000, 1100 can include various other steps.

As a non-limiting example, the method 900, 1000 can include acquiring or otherwise detecting the second set of characteristics including at least one operational characteristic. The operational characteristics can include at least one of, but are not limited to, a thermal emission, a water requirement, a drainage requirement, or a power requirement, or a space requirement of the household appliance. These operational characteristics can then be used to determine the limitations of the household appliance 12 within the environment 10. As a non-limiting example, the method 900, 1000 can further include determining a space required for at least one of opening a drawer or a door, the size of the household appliance 12, a clearance requirement, or a clearance recommendation of the household appliance 12 and whether or not the household appliance 12 is suitable for the environment 10. As another non-limiting example, the method 900, 1000 can further include determining whether or not the thermal emission of the household appliance 12 is suitable for the surrounding environment 10. As yet another non-limiting example, the method 900, 1000 can further include determining if the environment includes at least one suitable power/energy source or water source to accommodate for the power requirement or the water requirement, respectively, of the household appliance 12.

As another non-limiting example, the method 900, 1000 can further include acquiring or otherwise detecting the second set of characteristics in a second environment. The second environment can be different than the first environment (e.g., the environment 10). As a non-limiting example, the second environment can include, but are not limited to, retail stores, online stores, posters, magazines, newspapers, restaurants, another user's household, a different room of the user's household, a catalog, an online database or any combination thereof. The method 900, 1000 can further include simulating the household appliance 12 or the second set of characteristics of the household appliance 12, as captured from the second environment, within the environment 10.

As another non-limiting example, the method 900, 1000, 1100 can further include providing a recommendation to a user of the immersive reality device 14 regarding the household appliance 12. The recommendation can include at least one of, but is not limited to, a recommendation to call maintenance, a recommendation to order a new replacement household appliance 12, a recommendation to buy the household appliance 12, a recommendation to perform alterations of the environment 10 (e.g., install a vent, a drain, a gas line, a power source, a smoke detector, a carbon monoxide detector, a light, etc.), a recommendation to choose a different household appliance 12, or any combination thereof. As a non-limiting example, the method 900, 1000 can include recommending to the user how to position the household appliance 12 within the environment 10. The recommendations can be based on the second set of characteristics or the limitation of the household appliance 12 within the environment 10. As a non-limiting example, the limitation can be based on the thermal emission, the water requirement, the power requirement, the space requirement, or any combination thereof. The method 900, 1000, 1100 can further include simulating, on the immersive reality view 44, at least one recommendation. As a non-limiting example, a recommended positioning of the household appliance 12 within the environment 10 can be displayed to the user on the immersive reality view 44.

As another non-limiting example, the method 900, 1000 can include determining whether or not the household appliance 12 is appropriate for the environment 10 based on at least one of the first set of characteristics or the second set of characteristics. The method 900, 1000 can further include recommending to the user to buy the household appliance 12 if it is suitable for the environment 10. The method 900, 1000 can include recommending to the user not to buy the household appliance 12 if it not suitable for the environment 10. The method 900, 1000 can yet further include presenting a set of alternative household appliances 12 if the household appliance 12 or the set of household appliances 12 are not suitable for the environment. The alternative household appliances 12 being already determined, via the immersive reality deice 14, to be suitable for the environment 10.

As another non-limiting example, the method 900, 1000, 1100 can include simulating the immersive reality view 44 as an AR view 44 on an AR device 14. The method 900, 1000, 1100 can alternatively include simulating the immersive reality view 44 as a VR view 44 on an VR device 14. The method 900, 1000, 1100 can further include implementing the immersive reality view on at least one of a consumer telephone (e.g., a smartphone), a consumer computer, a consumer tablet, a consumer kiosk, a headset, a gaming platform, or a television in non-limiting examples.

As another non-limiting example, the method 900, 1000 can further include creating an audio recording or a visual recording of the household appliance 12 via the set of receiving components 16. the method 900, 1000, 1100 can further include comparing at least one of the audio recording or the visual recording to a set of audio recordings or a set of visual recordings, respectively, accessible via the immersive reality device 14 (e.g., through the memory 26). The method 900, 1000 can further include identifying the household appliance 12 (e.g., the type, make, model, registration, user, etc.) based on the audio recording or visual recording. The method 1100 can further include determining if, via the comparison, the audio pattern or the visual pattern is indicative of a fault of the household appliance 12. The method 900, 1000, 1100 can further include acquiring or otherwise detecting, via the receiving component 16, at least one of a visual pattern or a sound pattern produced by the household appliance 12 (e.g., the HMI 30). The visual pattern or the sound pattern can be indicative of the at least one characteristic of the household appliance 12 (e.g., the fault or non-fault condition). The sound pattern and the visual pattern can be generated via the HMI 30 of the household appliance 12 and be any suitable pattern such as, but not limited to, a visual indicator (e.g., an LED), an audio indicator (e.g., a speaker), a wireless transmitter, a wireless transponder, a wired connection, or any combination thereof. The patterns could further be used to determine a user's preference for how they use the household appliance 12.

It will be further appreciated that any comparison, as described herein, of the first set of characteristics and the second set of characteristics can be made through any suitable methods that can be used to determine at least one limitation as described herein based on at least one of the first set of characteristics or the second set of characteristics. It will be further appreciated that the first set of characteristics and the second set of characteristics can be obtained and the any of the suitable comparisons can be done through any other suitable method such as, but not limited to, pattern recognition (e.g., an audio or visual pattern), AI provided on or accessible to the immersive reality device 14, an at least partially trained ANN provided on or accessible to the immersive reality device 14, an EDS provided on or accessible to the immersive reality device 14, or any combination thereof.

As another non-limiting example, the method 900, 1000, 1100 can include determining the characteristics (e.g., the second set of characteristics) of at least one of, but not limited to, a virtual or non-virtual dishwasher, stove, oven, refrigerator, microwave, laundry treating appliance, coffee machine, blender, or mixer.

As yet another non-limiting example, the method 900, 1000, 1100 can include acquiring or otherwise detecting at least one constraint of the environment 10. The at least one constraint can include, but is not limited to, a size, a material, a power supply, a drain, or a water supply of the environment 10.

As another non-limiting example, the method 1100 can further include providing a recommendation to the user based on the at least one characteristic of the household appliance 12. The recommendation can generate in response to a fault occurring or if no fault has occurred. For example, the recommendation can be to continue using the household appliance 12 as usual if no fault was detected. If, however, a fault was detected the method 1100 can further include recommending at least one of buying a replacement part, requesting maintenance, resetting the household appliance 12, or buying a new household appliance 12 to address the fault. The method 1100 can further include, via the user interface 20, providing a link or a place (e.g., a retailer) to purchase at least one of the new household appliance 12, or the replacement part for the existing household appliance 12. The method 1100 can further include, via the user interface 20, providing a link, an address, or a phone number to request maintenance for the household appliance 12. As another non-limiting example, the method 1100 can further include recommending to the user at least one operation of the household appliance 12 based on the at least one characteristic, the at least one operation including at least one of a mode of operation, a cycle, a runtime, or a function of the household appliance 12. The method 1100 can further include determining the likelihood that a component of the household appliance 12 will fail. As a non-limiting example, the immersive reality device 14 could, via the receiving components 16, determine if a component of the household appliances 12 is going to break, or reach the end of its life cycle. If this is determined, the method 1100 can further including recommending the user replace the component or order a new component before the component breaks or reaches the end of its life cycle in the household appliance 12. This, in turn, can allow for preventative maintenance, thus ensuring that the household appliance 12 can continue to operate without it breaking down due to a faulty component.

As another non-limiting example, the method 900, 1000, 1100 can include accessing a handbook of the household appliance 12 (virtual or non-virtual). The handbook can be any suitable handbook of the household appliance 12 such as, but not limited to, a catalog, a manual, a maintenance manual, or any combination thereof. At least a portion of the handbook can be presented or simulated to the user through the immersive reality view 44. As a non-limiting example, the handbook can include a function of the household appliance (e.g., how to use the ice/water dispenser 32) and the immersive reality view 44 could display the sections of the handbook that explain the function. As another non-limiting example, the handbook can be a maintenance handbook that can present or simulate to the user how to perform maintenance on the household appliance 12.

As another non-limiting example, the method 900, 1000, 1100 can include providing instructions. The instructions can provide step-by-step instructions for a recipe, on how to use the household appliance 12, how to perform maintenance, how to order a new part, how to order a new household appliance 12, or how to call maintenance. If the household appliance 12 is determined to be faulty, the method 1100 can further include directing (through ten step-by-step instructions) the user toward at least one of a reset, or a component of the household appliance 12 based on the at least one characteristic. Instructions can be presented based on the direction given. For example, instructions may be presented to the user to reset the household appliance 12.

Benefits of the present disclosure include a method and system for providing instructions relating to a household appliance when compared to conventional instructional methods. For example, conventional instructional methods can require a user to read a physical manual, watch a video, talk to a person with familiarity with the household appliance, or go through trial-by-error methods in order to find out how to properly use, perform maintenance on or obtain the fullest capabilities of the household appliance. These methods can be time consuming and difficult for the user. The methods and systems as described herein, however, eliminate these time consuming and difficult tasks. This is done by presenting to the user a plethora of information through their immersive reality device in a succinct, easy to understand fashion. The immersive reality device with the immersive reality capabilities, as described herein, can provide instructions on how to use the household appliance, what each element of the household appliance is, and how to ensure that the user is using the household appliance to its fullest capabilities. All of this is done by the user pointing their immersive reality device toward the household appliance, or otherwise selecting a virtual household appliance, and selecting what they wish to do. The immersive reality view will then display to them, through the computer-generated elements, the requested information. This method eliminates the need for a user to read a physical manual, watch a video, talk to a person with familiarity with the household appliance, or go through trial-by-error methods in order to find out how to properly use, perform maintenance on or obtain the fullest capabilities of the household appliance.

Further benefits of the present disclosure include a method and system for presenting an immersive reality view of a household appliance when compared to conventional immersive reality views. For example, conventional immersive reality views can display various compute-generated elements that are constrained only the general function of the household appliance. The immersive reality view as described herein, however, provides for the creation of computer-generated that provide for a greater depth of knowledge of the household appliance. For example, the computer-generated elements as described herein can allow for a user to receive step-by-step instructions on how to use, how to fix, how to replace, or how to buy the household appliance. Conventional immersive reality views do not provide these types of computer-generated elements. Further yet, the immersive reality view as describe herein is not constrained solely to the household appliance. Computer-generated elements can be created for one or more limitations of the household appliance within the environment. These limitations are determined by determining at least one of the first set of characteristics of the environment and the second set of characteristics of the household appliance. The immersive reality view can then provide the computer-generated elements or otherwise simulate the limitations of the household appliance (e.g., the immersive reality view can simulate a door opening, a drawer opening, the use of the household appliance). These limitations can be simulated with respect to the environment. For example, if there is not enough room, the household appliance is not suitable for the material of the surrounding environment, or household appliance would not work within the environment, the immersive reality view would simulate this to the user through use of the computer-generated elements. Conventional immersive reality views do not do any of this, thus the present disclosure provides for an immersive reality view of greater depth, immersion, and containing more information than conventional immersive reality views.

Further benefits of the present disclosure include a method and system for shopping for a household appliance when compared to conventional shopping methods. For example, conventional shopping methods require a user to go to a physical retail shop, talk to a sales representative, or order through other methods (e.g., online, telephone, etc.). These conventional methods, however, fall short as the user is not able to physically place the household appliance within the environment they want it to be in. This can present various issues as the household appliance might not be suitable for the given environment, however, the user will not know this until after they have purchased the household appliance and bought it within the environment. The method and system as described herein, however, can be done completely virtually and ensure that the household appliances are completely suitable for the environment before the user buys the household appliances. The immersive reality view as described herein can allow for a user to place a virtual household appliance within the environment of their choosing. The user can then simulate various operations of the household appliance or determine limitations of the household appliance within the environment in order to decide whether or not they want to purchase the household appliances. For example, the user can open/close the door of virtual stove within the environment in order to see if the door will hit a neighboring portion of the environment. The simulation of the household appliance allows for a user to make a more informed decision when it comes to purchasing the household appliance. Further, if the user decides that the household appliance is not right for the environment, then alternative household appliances can be presented to the user. These alternative household appliances can be predetermined to work with the given environment. These methods and systems ensure that the user is making an informed decision when purchasing and eliminates the guess work that is associated with conventional shopping methods.

Benefits of the present disclosure include a method and system for diagnosing a household appliance when compared to conventional diagnostic methods. Conventional diagnostic methods normally require a person (e.g., a maintenance personnel) to take apart a portion of the household appliances to even determine what is wrong or what fault has occurred. The conventional diagnostic methods can include a lot of guess work and be very time consuming. Further, conventional diagnosing methods requiring a knowledge of how to fix the problems. The method and system as described herein, however, simplify the method for diagnosing and fixing a fault of a household appliance. The immersive reality device, via the audio recording or visual recording, can easily determine if a fault has occurred and what the fault is through the methods described. The detection and determination of the fault does not require portions of the household appliance to be removed, opened or exposed. Instead, the audio recording or the visual recording are able to easily detect what fault has occurred. Further, the immersive reality view can provide step-by-step instructions on how to fix the fault. These instructions can include recommendations to buy replacement parts/household appliances or steps on how to fix the fault. The instructions eliminate the need for pre-existing knowledge of how to fix the faults within the household appliance. This ultimately simplifies the method for diagnosing and fixing a household appliance when compared to conventional maintenance methods. Further yet, the method and system as described herein can be used to not only determine the need for maintenance (e.g., through the determination of a fault), but the immersive reality device can also automatically set up or order maintenance, or otherwise provide to the user of the immersive reality device nearby service providers who are authorized, sufficient or efficient in providing maintenance on the household appliance. This can ultimately result in a quicker, more efficient, and less time-consuming method for determining a fault, determining if maintenance is needed, or providing maintenance. Further yet, as discussed herein, the methods and systems described can be used to provide for preventative maintenance. This can be done by predicting when a component of the household appliances will fail or otherwise reach the end of its life cycle. As such, the immersive reality device can be used to address a problem with the household appliance before the problem even occurs, thus providing for preventative maintenance and increasing the ease and effectiveness of maintenance for the household appliance. Further yet, the immersive reality device as described herein can automatically send information relating to a fault of a household appliance to an authorized service center once the fault is detected by the immersive reality device. This, in turn, can optimize the maintenance process as the authorized service center can order parts, assign worktimes, or otherwise prepare to address the fault. This ultimately increases the overall efficiency of the maintenance process as the authorized service center (e.g., the people who will perform the maintenance) can get a head start on addressing the fault when compared to traditional methods of performing maintenance.

To the extent not already described, the different features and structures of the various aspects can be used in combination with each other as desired, or can be used separately. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described.

While the present disclosure has been specifically described in connection with certain specific aspects thereof, it is to be understood that this is by way of illustration and not of limitation. Reasonable variation and modification are possible within the scope of the forgoing disclosure and drawings without departing from the spirit of the present disclosure. Hence, specific dimensions and other physical characteristics relating to the aspects disclosed herein are not to be considered as limiting, unless expressly stated otherwise.

Further aspects of the disclosure are provided by the subject matter of the following clauses:

A method of implementing an immersive reality view on a device having a user interface and at least one receiving component, the method comprising acquiring a first set of characteristics of an environment via the at least one receiving component, acquiring a second set of characteristics associated with a household appliance, via the at least one receiving component, comparing the second set of characteristics to the first set of characteristics to determine one or more limitations of the household appliance, and simulating the immersive reality view on the user interface of the device, the immersive reality view illustrating the household appliance within the environment and including the one or more limitations.

The method of any preceding clause, wherein the first set of characteristics comprises at least one constraint of the environment and the second set of characteristics comprises a set of operational characteristics of the household appliance.

The method of any preceding clause, wherein the determined one or more limitations includes at least one operational characteristic of the household appliance, wherein the at least one operational characteristic includes at least one of: a) a status of the household appliance, b) a thermal emission of the household appliance, c) a water requirement of the household appliance, d) a gas requirement of the household appliance, e) a power requirement of the household appliance, f) a clearance requirement of the household appliance, g) a venting requirement of the household appliance, h) a drainage requirement of the household appliance, i) a light requirement of the household appliance, j) a space requirement of the household appliance, k) a maintenance requirement of the household appliance, l) a registration requirement of the household appliance, or m) a network connection requirement.

The method of any preceding clause, wherein the at least one operational characteristic includes the space requirement of the household appliance, and the method can further comprises determining a space required for at least one of opening a drawer or a door, the size of the household appliance, a clearance requirement, or a clearance recommendation of the household appliance.

The method of any preceding clause, wherein the at least one operational characteristic includes the thermal emission of the household appliance during operation of the household appliance, and the method further comprises determining if the thermal emission of the household appliance exceeds a temperature rating of the at least a portion of the environment.

The method of any preceding clause, wherein the at least one operational characteristic includes at least one of the power requirement, the water requirement, or the drainage requirement of the household appliance, and the method further comprises determining if the environment includes at least one suitable energy source, water source, or drain to accommodate of the power requirement, the water requirement, or the drain requirement, respectively.

The method of any preceding clause, further comprising acquiring the second set of characteristics of the household appliance in a second environment, wherein the second environment is a retail store, or is obtained from catalog, or an online database.

The method of any preceding clause, further comprising providing, to the user through the immersive reality view, a recommendation concerning the determined one or more limitations of the household appliance within the environment, the recommendation including at least one of a) a recommendation to pursue maintenance for the household appliance, b) a recommendation to buy the household appliance, c) a recommendation to not buy the household appliance, d) a recommendation to buy a new household appliance, e) a recommendation to buy a replacement part for the household appliance, f) a recommendation to install at least one of a vent, a drain, a power source, a gas line, a smoke detector, a carbon monoxide detector, or a light within the environment, g) a recommendation to select a different household appliance, or h) a recommendation for a positioning of household appliance or a portion of the environment, within the environment.

The method of any preceding clause, further comprising providing, through the immersive reality view, the recommendation for the positioning of the household appliance within the environment.

The method of any preceding clause, wherein the recommendation for the positioning of the household appliance within the environment is based on at least one of a thermal emission, a water requirement, or a power requirement, a drain requirement, or a space requirement of the household appliance.

The method of any preceding clause, further comprising determining whether or not the household appliance is suitable for the environment via a comparison of the first set of characteristics or the second set of characteristics.

The method of any preceding clause, further comprising providing, to the user through the immersive reality view, a recommendation to buy the household appliance if the household appliance is suitable for the environment.

The method of any preceding clause, further comprising providing, to the user through the immersive reality view, a recommendation to not buy the household appliance if at least one of the one or more limitations of the household appliance is not suitable for the environment, determining at least one alternative household appliance suitable for the environment, and providing, through the immersive reality view, the user with the at least one alternative household appliance.

The method of any preceding clause, wherein the determination of whether or not the household appliance is suitable for the for the environment comprises determining whether at least one of a space requirement, an energy requirement, a water requirement, a venting requirement, a drain requirement, a performance requirement, or a gas requirements is met by the environment.

The method of any preceding clause, further comprising at least one of simulating a real-time augmented reality view or a real-time virtual reality view on the user interface of the immersive reality device.

The method of any preceding clause, further comprising implementing the immersive reality view on the device including at least one of a consumer telephone, a consumer computer, a consumer tablet, or a consumer kiosk, and wherein the at least one receiving component is at least one of a camera, a microphone, a Bluetooth module, a WIFI module, a memory accessible to the device, or a near field communication module of the device.

The method of any preceding clause, further comprising determining the second set of characteristics of at least one of a dishwasher, a stove, an oven, a refrigerator, a microwave, or a laundry treating appliance.

The method of any preceding clause, further comprising generating, through a processor accessible to the device, at least one computer-generated element corresponding to the one or more limitations, and displaying, on the immersive reality view, the computer-generated elements.

The method of any preceding clause, wherein acquiring the first set of characteristics includes detecting, via the at least one receiving component, at least one constraint of the environment including at least one of a size, a void, a material, an energy supply, a temperature rating, a drain, a usage, a normative requirement, an accessibility, or a water supply of the environment.

A method of implementing an immersive reality view on an immersive reality device having a user interface, at least one receiving component, and an accessible memory, the method comprising acquiring a first set of characteristics of an environment via the at least one receiving component, wherein the first set of characteristics comprises at least one constraint of the environment, receiving a set of household appliances from the memory, with each household appliance including a second set of characteristics corresponding to at least one of a thermal emission, a water requirement, a drainage requirement, a light requirement, or a power requirement, or a space requirement of the household appliance, comparing the second set of characteristics to the first set of characteristics, determining which household appliance of the set of household appliances would be suitable for the environment based on the comparison, and simulating the immersive reality view on the user interface of the immersive reality device, the immersive reality view illustrating the determined household appliance within the environment.

A method of diagnosing a household appliance on a device having user interface, a receiving component, and an accessible memory, the method comprising acquiring a status of the household appliance via the receiving component, determining at least one characteristic of the household appliance based on the status, determining whether [or not] the at least one characteristic is indicative of a fault associated with the household appliance, and simulating a immersive reality view of the device of the at least one characteristic.

The method of any preceding clause, further comprising providing a recommendation to a user of the immersive reality device based on the at least one characteristic.

The method of any preceding clause, further comprising indicating, via the user interface, if the at least one characteristic is indicative of a fault.

The method of any preceding clause, further comprising recommending at least one of buying a replacement part, requesting maintenance, resetting the household appliance, replacing a consumable for, or buying a new household appliance if the at least one characteristic is indicative of a fault

The method of any preceding clause, further comprising providing, via the user interface, a link or a place to purchase at least one of the new household appliance, the consumable, or the replacement part to the user.

The method of any preceding clause, further comprising providing, via the user interface, a link or a phone number to request maintenance for the household appliance.

The method of any preceding clause, further comprising supplying information to an authorized service center, wherein the information includes at least one of a general description of the fault, a recommended remedy of the fault, at least one needed replacement part to fix the fault, a set of steps to fix the fault, a location of the household appliance, or contact information for a user of the household appliance.

The method of any preceding clause, further comprising providing step-by-step instructions on how to resolve the fault if the at least one characteristic is indicative of a fault.

The method of any preceding clause further comprising directing the user toward at least one of a reset, or a component of the household appliance based on the at least one characteristic.

The method of any preceding clause, wherein the status is acquired through at least one of an audio recording, a visual recording, or a wireless transmission.

The method of any preceding clause, further comprising comparing at least one of the audio recording or the visual recording to a set of audio recordings or a set of visual recordings, respectively, accessible via the memory.

The method of any preceding clause, further comprising detecting, via the receiving component, at least one of a visual pattern or a sound pattern produced by the household appliance, the visual pattern and the sound pattern being indicative of the at least one characteristic of the household appliance.

The method of any preceding clause, further comprising comparing at least one of the sound pattern or the visual pattern with a set of sound patterns or a set of visual patterns, respectively, accessible via the memory, and determining, via the comparison, if the at least one characteristic is indicative of a fault.

The method of any preceding clause, further comprising determining a user's preferences for use of the household appliance through at least one of the audio pattern or the visual pattern.

The method of any preceding clause, further comprising recommending at least one operation of the household appliance based on the at least one characteristic, the at least one operation including at least one of a mode of operation, a cycle, a runtime, or a function of the household appliance.

The method of any preceding clause, further comprising accessing a handbook of the household appliance, the handbook including at least one of a user manual, or a maintenance manual, and displaying on the simulation at least a portion of the handbook corresponding to the at least one characteristic.

The method of any preceding clause, wherein the fault corresponds to at least one of a broken part of the household appliance, a need for cleaning of the household appliance, or a need for at least one consumable of the household appliance.

The method of any preceding clause, wherein the fault is at least one of a need for cleaning the household appliance or a need for at least one consumable of the household appliance, the method further comprising providing step-by-step instructions for cleaning the household appliance or supplying the at least one consumable.

The method of any preceding clause, further comprising simulating at least one of a real-time augmented reality view or a real-time virtual reality view of the household appliance and the at least one characteristic.

The method of any preceding clause, further comprising implementing an immersive reality device on at least one of a consumer telephone, a consumer computer, a consumer tablet, or a consumer kiosk.

1. A method of implementing an immersive reality view on a device having a user interface and at least one receiving component, the method comprising:
acquiring a first set of characteristics of an environment via the at least one receiving component;
acquiring a second set of characteristics associated with a household appliance, via the at least one receiving component;
comparing the second set of characteristics to the first set of characteristics to determine one or more limitations of the household appliance; and
simulating the immersive reality view on the user interface of the device, the immersive reality view illustrating the household appliance within the environment and including the one or more limitations.

2. The method of claim 1, wherein the first set of characteristics comprises at least one constraint of the environment and the second set of characteristics comprises a set of operational characteristics of the household appliance.

3. The method of claim 1, wherein the determined one or more limitations includes at least one operational characteristic of the household appliance, wherein the at least one operational characteristic includes at least one of:
a) a status of the household appliance;
b) a thermal emission of the household appliance;
c) a water requirement of the household appliance;
d) a gas requirement of the household appliance;
e) a power requirement of the household appliance;
f) a clearance requirement of the household appliance;
g) a venting requirement of the household appliance;
h) a drainage requirement of the household appliance;
i) a light requirement of the household appliance;
j) a space requirement of the household appliance;
k) a maintenance requirement of the household appliance;
l) a registration requirement of the household appliance; or
m) a network connection requirement.

4. The method of claim 3, wherein the at least one operational characteristic includes the space requirement of the household appliance, and the method further comprises determining a space required for at least one of opening a drawer or a door, a size of the household appliance, a clearance requirement, or a clearance recommendation of the household appliance.

5. The method of claim 3, wherein the at least one operational characteristic includes the thermal emission of the household appliance during operation of the household appliance, and the method further comprises determining if the thermal emission of the household appliance exceeds a temperature rating of the at least a portion of the environment.

6. The method of claim 3, wherein the at least one operational characteristic includes at least one of the power requirement, the water requirement, or the drainage requirement of the household appliance, and the method further comprises determining if the environment includes at least one suitable energy source, water source, or drain to accommodate of the power requirement, the water requirement, or the drain requirement, respectively.

7. The method of claim 1, further comprising acquiring the second set of characteristics of the household appliance in a second environment, wherein the second environment is a retail store, or is obtained from catalog, or an online database.

8. The method of claim 1, further comprising providing, to the user through the immersive reality view, a recommendation concerning the determined one or more limitations of the household appliance within the environment, the recommendation including at least one of:
a) a recommendation to pursue maintenance for the household appliance;
b) a recommendation to buy the household appliance;
c) a recommendation to not buy the household appliance;
d) a recommendation to buy a new household appliance;
e) a recommendation to buy a replacement part for the household appliance;
f) a recommendation to install at least one of a vent, a drain, a power source, a gas line, a smoke detector, a carbon monoxide detector, or a light within the environment;
g) a recommendation to select a different household appliance; or
h) a recommendation for a positioning of household appliance or a portion of the environment, within the environment.

9. The method of claim 8, further comprising providing, through the immersive reality view, the recommendation for the positioning of the household appliance within the environment.

10. The method of claim 9, wherein the recommendation for the positioning of the household appliance within the environment is based on at least one of a thermal emission, a water requirement, or a power requirement, a drain requirement, or a space requirement of the household appliance.

11. The method of claim 1, further comprising determining whether or not the household appliance is suitable for the environment via a comparison of the first set of characteristics or the second set of characteristics.

12. The method of claim 11, further comprising providing, to the user through the immersive reality view, a recommendation to buy the household appliance if the household appliance is suitable for the environment.

13. The method of claim 11, further comprising:
providing, to the user through the immersive reality view, a recommendation to not buy the household appliance if at least one of the one or more limitations of the household appliance is not suitable for the environment;
determining at least one alternative household appliance suitable for the environment; and
providing, through the immersive reality view, the user with the at least one alternative household appliance.

14. The method of claim 11, wherein the determination of whether or not the household appliance is suitable for the environment comprises determining whether at least one of a space requirement, an energy requirement, a water requirement, a venting requirement, a drain requirement, a performance requirement, or a gas requirements is met by the environment.

15. The method of claim 1, further comprising at least one of simulating a real-time augmented reality view or a real-time virtual reality view on the user interface of the immersive reality device.

16. The method of claim 1, further comprising implementing the immersive reality view on the device including at least one of a consumer telephone, a consumer computer, a consumer tablet, or a consumer kiosk, and wherein the at least one receiving component is at least one of a camera, a microphone, a Bluetooth module, a WIFI module, a memory accessible to the device, or a near field communication module of the device.

17. The method of claim 1, further comprising determining the second set of characteristics of at least one of a dishwasher, a stove, an oven, a refrigerator, a microwave, or a laundry treating appliance.

18. The method of claim 1, further comprising:
generating, through a processor accessible to the device, at least one computer-generated element corresponding to the one or more limitations; and
displaying, on the immersive reality view, the computer-generated elements.

19. The method of claim 1, wherein acquiring the first set of characteristics includes detecting, via the at least one receiving component, at least one constraint of the environment including at least one of a size, a void, a material, an energy supply, a temperature rating, a drain, a usage, a normative requirement, an accessibility, or a water supply of the environment.

20. A method of implementing an immersive reality view on an immersive reality device having a user interface, at least one receiving component, and an accessible memory, the method comprising:
acquiring a first set of characteristics of an environment via the at least one receiving component, wherein the first set of characteristics comprises at least one constraint of the environment;
receiving a set of household appliances from the memory, with each household appliance including a second set of characteristics corresponding to at least one of a thermal emission, a water requirement, a drainage requirement, a light requirement, or a power requirement, or a space requirement of the household appliance;
comparing the second set of characteristics to the first set of characteristics;
determining which household appliance of the set of household appliances would be suitable for the environment based on the comparison; and
simulating the immersive reality view on the user interface of the immersive reality device, the immersive reality view illustrating the determined household appliance within the environment.
